(19) United States
(12) Patent Application Publication
(10) Pub. No.: US 2026/0238099 A1
(43) Pub. Date: Aug. 13, 2026

(54) SUPPORT, USE THEREOF DURING TRICKLE IMPREGNATION, TRICKLING SYSTEM, SYSTEM COMPONENT THEREOF, AND TRICKLE IMPREGNATION METHOD

(71) Applicant: GROB-WERKE GmbH & Co. KG, MINDELHEIM (DE)

(72) Inventors: Ralf RAUSCHER, FELLHEIM (DE); Robert ZOLLER, WINTERRIEDEN (DE); Georg SCHRETZENMAIER, BURGAU (DE); Manuel SALGER, DIRLEWANG (DE); Johannes HEIMPEL, MINDELHEIM (DE)

(21) Appl. No.: 19/154,943

(22) PCT Filed: Oct. 27, 2023
(86) PCT No.: PCT/EP2023/080162

§ 371 Date: Aug. 8, 2025

(30) Foreign Application Priority Data
Feb. 10, 2023 (DE) 10 2023 103 270.4
Mar. 24, 2023 (DE) 10 2023 107 558.6

(51) Int. Cl. H02K 15/122; B05C 5/02; B05C 13/02

(52) U.S. Cl. CPC H02K 15/122; B05C 5/0291; B05C 13/02

(57) ABSTRACT

For impregnating stators in mass production, a device includes holders with at least one rolling surface and unit components of an impregnation unit with a rolling device, on which the holders with clamped-in stators or, even in the case of stators with a cylindrical outer surface suitable as a rolling surface, the stators themselves lie purely as a result of gravity.

### CROSS-REFERENCE TO RELATED APPLICATIONS

This application is a national phase of International Patent Application No. PCT/EP2023/080162, filed on Oct. 27, 2023, which claims the benefit of German Patent Application No. 10 2023 103 270.4, filed Feb. 10, 2023, and German Patent Application No. 10 2023 107 558.6, filed Mar. 24, 2023, the entire disclosures of which are incorporated herein by way of reference.

### FIELD OF THE INVENTION

The invention relates to a holder for holding, rotating and transporting a stator in the course of an impregnation of the stator with resin. Furthermore, the invention relates to the use of a holder of this type for holding a stator in the course of a trickle impregnation. Furthermore, the invention relates to a unit component of an impregnation unit for the impregnation of stators in series production, which is configured to handle a stator held in a holder of this type. Furthermore, the invention relates to a trickle unit for the trickle impregnation of stators, comprising a plurality of holders of this type. Finally, the invention relates to a method, in which a stator is held in a holder of this type for the trickle impregnation.

### BACKGROUND OF THE INVENTION

Reference is made to the following citations in respect of the technological background:

| | |
|---|---|
| [1] | DE 1 279 156 A |
| [2] | DE 10 2019 120 713 A1 |
| [3] | DE 10 2017 001 939 A1 |
| [4] | DE 10 2019 121 956 A1 |
| [5] | US 3 696 420 A1 |
| [6] | JP 2015-76984 A |
| [7] | JP 2015-318692 A |
| [8] | WO 2022/171353 A1 |
| [9] | DE 10 2019 106 392 A1 |
| [10] | WO 2019/123137 A1 |
| [11] | WO 2018/154277 A1 |
| [12] | DE 10 2021 105 959 A1 |
| [13] | DE 10 2019 004 954 B3 |

Citations [1] to [13] have disclosed units, apparatuses and methods which are used during an impregnation of stators, in particular during trickle impregnation. Here, stators are clamped into holders.

### SUMMARY OF THE INVENTION

The invention is based on an object of providing improved possibilities for handling stators during a trickle impregnation to be carried out in the course of industrial mass production.

To achieve this object, the invention provides a holder according to one or more embodiments described herein. The advantageous use of the holder, a unit component for handling a stator which is held in a holder of this type, and a method for trickle impregnation with the use of a holder of this type are disclosed herein as well in various embodiments.

In accordance with a first aspect thereof, the invention creates a holder for holding, rotating and transporting a stator in the course of an impregnation of the stator with resin, wherein the holder has a clamping device for clamping in the stator and at least one rolling surface for rolling support of the rotating holder with a clamped-in-stator.

The holder is preferably configured as a cage which surrounds the clamped-in-stator during use.

It is preferred that the at least one rolling surface is a rolling surface which runs around the stator which is clamped in during use.

Note: within the context of the present disclosure, “the at least one rolling surface” can mean a single rolling surface which is provided on the holder, one of a plurality of rolling surfaces which are provided on the holder, some of a plurality of rolling surfaces which are provided on the holder, or all the rolling surfaces which are provided on the holder.

It is preferred that the at least one rolling surface is provided on an outer periphery, projecting radially to the furthest extent, of the holder.

It is preferred that at least one first and at least one second axially spaced-apart rolling surface are provided.

It is preferred that the first rolling surface is provided on a first axial end region of the holder, and that the second rolling surface is provided on a second axial end region of the holder.

It is preferred that the at least one rolling surface is configured on at least one ring region of the holder.

It is preferred that the first rolling surface is configured on a first ring element of the holder, and the second rolling surface is configured on a second ring element of the holder, and that the first and the second ring element are connected axially to one another.

It is preferred that ring elements of the holder are connected to one another by means of axial struts.

It is preferred that the first and second rolling surface have an identical diameter.

It is provided in some embodiments that the at least one rolling surface or at least one of a plurality of rolling surfaces is of conical configuration at least in regions. It is provided in some embodiments that the at least one rolling surface or at least one of a plurality of rolling surfaces is of spherical configuration at least in regions. It is provided in some embodiments that the at least one rolling surface or at least one of a plurality of rolling surfaces is configured at least in regions in a convexly curved manner in axial section. It is provided in some embodiments that the at least one rolling surface or at least one of a plurality of rolling surfaces is configured at least in regions in a concavely curved manner in axial section. It is provided in some embodiments that the at least one rolling surface or at least one of a plurality of rolling surfaces has at least one groove. It is provided in some embodiments that the at least one rolling surface or at least one of a plurality of rolling surfaces has a peripheral annular projection or a peripheral rib.

It is preferred that the at least one rolling surface has at least one first peripheral conical region and at least one second peripheral conical region, wherein the first and the second conical region are inclined in a manner which is directed counter to one another and/or are of mirror-inverted configuration with respect to one another.

It is preferred that a peripheral toothing system is provided for driving a rotation of the holder in a positively locking manner with a clamped-in-stator.

It is preferred that the toothing system is configured on a dedicated ring element of the holder or on a ring element which also has the rolling surface or one of a plurality of rolling surfaces.

It is preferred that the clamping device is provided to clamp in the stator in a radial and/or axial positively locking and/or non-positive manner on an outer side of the stator.

It is preferred that the clamping device has radially movable clamping elements with radially inwardly directed clamping surfaces and/or axially movable clamping elements with clamping surfaces which are directed axially towards one another.

It is preferred that the clamping elements are arranged radially movably on the struts.

It is preferred that the clamping device has at least one thread for moving at least one clamping element of the clamping device by screwing.

It is preferred that the clamping device has at least one spring for elastically clamping in the stator.

It is preferred that the clamping device is configured to receive the stator in a release position without dismantling clamping elements of the clamping device.

It is preferred that the clamping device has clamping elements which are arranged radially within the at least one rolling surface.

It is preferred that clamping elements of the clamping device are configured on ring elements of the holder, on the outer periphery of which the at least one rolling surface is configured.

It is preferred that the struts are configured as telescopic elements.

It can also be provided in some embodiments that the clamping device has at least one bayonet lock receptacle with a slot for plugging through a radial projection of the stator and the holding region, arranged offset rotationally with respect to the slot, for holding the radial projection.

It is provided in some embodiments that the clamping device has a plurality of bayonet lock receptacles which are provided offset with respect one another in the peripheral direction or distributed over the periphery.

It is provided in some embodiments that the clamping device has at least a first and a second bayonet lock receptacle which are arranged at different axial positions.

It is provided in some embodiments that the at least one bayonet lock receptacle is configured on a ring element of the holder, on the outer periphery of which the at least one rolling surface or one of a plurality of rolling surfaces is configured.

The holders for the stators are preferably configured in such a way that the stator is received or clamped on the external diameter or the outer contour. The holders are preferably configured in such a way that the two axial sides of the stator (winding head sides) are freely accessible.

The holder is preferably configured as a cage. In particular, the holder is configured in such a way that it does not project axially beyond a laminated core of a stator which is clamped into it during operation.

Accordingly, the invention in accordance with a further aspect also creates an arrangement comprising the holder in accordance with one of the preceding embodiments or one of the embodiments described in the following text, and the stator which is to be held or is held therein.

In accordance with a further aspect, the invention proposes the use of a holder in accordance with one of the preceding refinements for holding and rotating a stator in the course of a trickle impregnation during trickling and gelling.

It is preferred that the holder with a clamped-in-stator is held solely by gravity in a gelling device for gelling by placing the at least one rolling surface on a rolling device of the gelling device, and is rotated about a rotational axis which coincides with a central axis of the stator.

The at least one rolling surface of the holder is preferably arranged axially in the region of the laminated core of the stator, wherein the holder does not project beyond the laminated core.

It is preferred that the holder with a clamped-in-stator is held solely by gravity in a trickle device for trickle impregnation by placing the at least one rolling surface on a rolling device of the trickle device, and is rotated about a rotational axis which coincides with the central axis of the stator.

It is preferred that the holder which rolls on the rolling device of the trickle device is inclined during trickling by means of the rolling device about a substantially horizontal swivel axis which extends transversely with respect to the rotational axis.

It is preferred that the holder with a clamped-in-stator is lifted for trickling from a delivery track by means of the rolling device of the trickle device.

It is preferred that the respective rolling device has a plurality of guide elements, on which the at least one rolling surface is placed, wherein the guide elements are configured to guide the holder in such a way that it carries out a concentric rotation about its longitudinal axis.

It is preferred that the guide elements of the rolling device are selected from a group which comprises rollers, pinions, contoured wheels, toothing systems, rails, circulating chains, running surfaces, rollers with flanged discs, rollers with V-shaped grooves, rollers with a spherical running surface, rollers with an annular projection on the running surface, rollers with grooves on the running surface, rollers which are connected by means of a chain or a conveyor belt, actively driven rollers, actively driven pinions, and rollers, pinions and contoured wheels which are connected by a common shaft.

It is preferred that at least one of the guide elements of the rolling device introduces the rotational movement into the holder.

It is preferred that the guide elements or at least some of them can be rotated about in each case one rotational axis, the position of which differs from the position of the rotational axis of the holder.

It is preferred that the guide elements comprise a first to fourth roller, wherein the first and second roller act, spaced apart axially from one another, on the at least one rolling surface of the holder in an angular position between 3 o'clock and 6 o'clock, and the third and fourth roller act, spaced apart axially from one another, on the at least one rolling surface in an angular position between 6 o'clock and 9 o'clock.

It is preferred that the respective rolling device has adjacent bearing positions for a first and a second holder, wherein a common shaft or roller is arranged between the bearing positions, on which shaft or roller the first holder and the second holder lie, with the result that a rotation of the one holder can be transmitted via the common shaft or roller to the second holder, or that the first and the second holder are driven rotationally via the common shaft or roller.

It is preferred that a sequence of stators are impregnated by trickle impregnation in mass production, wherein each stator is held for trickling and gelling in a dedicated holder in accordance with one of the preceding refinements.

In accordance with a further aspect, the invention creates a unit component of an impregnation unit for the impregnation of stators in mass production, comprising a rolling device which is configured to hold one or more holders in accordance with one of the preceding refinements in each case with a clamped-in stator by placing the at least one rolling surface on the rolling device, and to rotate it/them about a rotational axis which coincides with a central axis of the stator.

The unit component can be, for example, a gelling device for gelling resin which has previously been introduced into the stator.

It is preferred that the gelling device is selected from the group which comprises a convection oven, a gelling device with an induction coil, a stationary gelling device, to which the stators which are held in the holders are transported after the resin application, or a continuous oven, through which the stators which are held in the holders are passed sequentially.

Furthermore, the unit component can be, for example, a trickle device with at least one trickle nozzle for trickling on resin.

In the case of a configuration of the unit component as a trickle device, in particular, it is preferred that the rolling device is configured to lift the at least one holder rolling on it with a stator clamped in it and/or to incline it relative to the horizontal.

It is preferred that a plurality of trickle nozzles are provided for trickling resin onto winding heads on both sides of the stator which is clamped in in the holder.

The unit component can also be a curing device for curing the initially gelled resin.

The unit component can also be a transport device for transporting a series of holders, wherein a plurality of the rolling devices are arranged on a conveyor belt.

It is preferred that the rolling device has a plurality of guide elements, onto which the at least one rolling surface can be placed, wherein the guide elements are configured to guide the holder in such a way that it performs a concentric rotation about its longitudinal axis.

It is preferred that the guide elements of the rolling device are selected from a group which comprises rollers, pinions, contoured wheels, toothing systems, rails, circulating chains, running surfaces, rollers with flanged discs, rollers with V-shaped grooves, rollers with a spherical running surface, rollers with an annular projection on the running surface, rollers with grooves on the running surface, rollers which are connected by means of a chain or a belt, actively driven rollers, actively driven pinions, and rollers, pinions and contoured wheels which are connected by a common shaft.

It is preferred that at least one of the guide elements of the rolling device is configured to introduce the rotational movement into the holder.

It is preferred that the guide elements or at least some of them can be rotated about in each case one rotational axis, the position of which differs from the position of the rotational axis of the holder.

It is preferred that the guide elements comprise a first to fourth roller, wherein the first and second roller act, spaced apart axially from one another, on the at least one rolling surface of the holder in an angular position between 3 o'clock and 6 o'clock, and the third and fourth roller act, spaced apart axially from one another, on the at least one rolling surface in an angular position between 6 o'clock and 9 o'clock.

It is preferred that the rolling device has adjacent bearing positions for a first and a second holder, wherein a common shaft or roller is arranged between the bearing positions and is configured such that the first holder and the second holder lie on it, with the result that a rotation of the one holder can be transmitted via the common shaft or roller to the second holder, or that the first and the second holder are driven rotationally via the common shaft or roller.

One aspect of the invention relates to an impregnation unit for the impregnation of stators in mass production, comprising a transport device for transporting a series of stators through regions of the impregnation unit, wherein the transport device has a circulating transport track with an infeed region and a return region and deflection regions in between, and a conveyor belt which is configured such that the stators can be placed onto or lifted from the conveyor belt transversely with respect to the respective stator axis and lie at least in sections rotationally on the conveyor belt during transport through the infeed or return region.

It is preferred that the conveyor belt is arranged in the infeed region below the stator axes of the stators which are situated in the infeed region during operation, with the result that the stators can be transported through the infeed region of the transport track in a manner which lies on the conveyor belt, and that the transport device has, in the return region, a running surface for the stators which are to be transported through the return region to lie on.

It is preferred that the conveyor belt is arranged in the return region above the stators which are situated in the return region during operation, and is configured to drive the movement of the stators which roll on the running surface.

It is preferred that a loading and unloading station is arranged at a start of the infeed region of the circulating transport track, and is configured in such a way that the stators can be placed onto and lifted from the conveyor belt transversely with respect to the stator axis.

It is preferred that the deflection regions have deflection curves for grasping the stators and deflecting their movement paths.

It is preferred that the infeed region and the return region are arranged above one another, or that the infeed region is arranged above the return region.

It is preferred that the infeed region of the transport track leads through an impregnation region and a gelling region of the impregnation unit, wherein a rotary drive mechanism for driving a rotational movement of the stators which lie on the conveyor belt is provided in the impregnation region and the gelling region.

It is preferred that the return region and/or at least one of the deflection regions lead/leads through a curing region of the impregnation unit which lies downstream of a gelling region in the transport direction.

It is preferred that the conveyor belt has at least one circulating traction mechanism and rolls or rollers attached thereto for the stators to lie on in a rolling manner, which rollers or rolls can be rotated about rotational axes which run transversely with respect to the transport direction.

It is preferred that the rollers or rolls are selected from a group which comprises rollers with flanged discs, rollers or rolls with pinions, rollers with V-shaped grooves, rollers with a spherical running surface, rollers with an annular projection on the running surface, rollers with grooves on the running surface, actively driven rollers, actively driven pinions, and rollers, pinions and contoured wheels which are connected by a common shaft.

It is preferred that receiving regions on the conveyor belt for acting on a stator in each case comprise a first to fourth roller, wherein the first and second roller are arranged spaced apart axially from one another so as to act on at least one rolling surface of the cylindrical stator or a holder which holds the stator in an angular position between 3 o'clock and 6 o'clock, and the third and fourth roller are arranged spaced apart axially with respect to one another so as to act on the at least one rolling surface in an angular position between 6 o'clock and 9 o'clock.

It is preferred that the conveyor belt or a rolling device of the impregnation unit has adjacent receiving spaces for a first and the second stator, wherein a common shaft or roller is arranged between the receiving spaces, which shaft or roller is configured such that the first and second stator lie on it, with the result that the rotation of the one stator can be transmitted via the common shaft or roller to the second stator, or that the first and second stator are driven rotationally via the common shaft or roller.

It is preferred that, in addition to the circulating traction mechanism, the conveyor belt has, at least on one of the infeed region and the return region, a second traction mechanism which can be moved independently of the circulating traction mechanism and is configured to drive a rotational movement of the stators or the rollers or rolls.

Preferred refinements of the invention relate to an impregnation unit, in particular a trickle unit, with a conveying principle which is configured as a circulation system.

In some embodiments, the impregnation unit has a plurality of unit regions or unit components, through which stators can be conducted by means of the conveyor belt.

For example, the impregnation unit which is configured, for example, as a trickle unit has at least some of the following unit components: trickle device, gelling device and curing device.

The impregnation unit preferably has a handling unit for loading, unloading or transferring stators. In some embodiments, the handling unit is configured to grasp in each case at least one stator on its inner periphery. In some embodiments, the handling unit is configured to grip the at least one holder.

In particularly preferred refinements, the conveyor belt has rolling devices which are configured for the rotational support of the at least one rolling surface on the stator or the holder, wherein the conveyor belt is configured to convey the stators which are held in the holders or the cylindrical stators themselves through a plurality of unit components which are arranged behind one another in the conveying direction.

The impregnation unit preferably has a loading station which is configured for placing a group of stators which are held in the holders in batches onto the conveyor belt.

In particularly preferred refinements, different unit components or regions of the impregnation unit are distributed to a plurality of levels, with the result that an infeed run of the conveyor belt is configured for the transport of the stators in one level, and a returning run of the conveyor belt is configured for the transport in a further level. For example, one of the runs is, in particular, configured and arranged in such a way that the stators (possibly clamped into holders which are configured, in particular, as cages) lie on it, and the conveyor belt therefore acts below the stators, and the other run of the conveyor belt is configured and arranged in such a way that the conveyor belt acts above the stators. The infeed run preferably runs in an upper level, with the result that the stators lie on it and can be driven rotationally, and the returning run runs in a lower level, without a separate rotary drive for the stators.

In accordance with a further aspect, the invention creates an impregnation method for the impregnation of stators in mass production with the use of an impregnation unit in accordance with one of the preceding refinements.

In some embodiments, the stators are clamped in a respective holder during the trickling and during the gelling.

In some embodiments, the stators are transported from the trickling into the gelling by way of the transport device/conveying system with at the same time maintenance of the rotation about the horizontally lying rotational axis (no interruption in the rotation). In some embodiments, the one level is a trickle and gelling level, where trickling and gelling take place.

In some embodiments, the transport device is configured in such a way that the stators are fed directly to the transport device transversely with respect to the stator rotational axis and can be removed by this transport device, in order to be lifted, for example, upward for trickling and swivelling.

In some embodiments, a linear gantry is provided for loading and/or unloading at a loading station as handling unit, by way of which at least one stator or preferably a group of stators (batch) can be placed on the conveyor belt transversely with respect to the stator axis and/or can be lifted from this conveyor belt transversely with respect to the stator axis.

The stators do not have to be moved axially for loading and unloading. The winding head sides are more accessible.

In embodiments of the invention, the transport device is configured in such a way that no active clamping or actuating, that is to say no actuating system, is required for fixing the stator on the conveying system.

In some embodiments, the conveying system (the transport system, in particular for the transport from trickling to gelling) is configured as a circulating system which is capable of also transporting the stators in a circulating manner.

One of the advantages of a circulating system of this type is that, in the case of failure or disruption of a component, for example if the loading system fails, the trickling and gelling process does not have to be interrupted, since the stators are simply circulated further in a synchronized manner. There is no disadvantage if the stators run through the unit multiple times, since the trickle process is simply carried out in a “dry” manner in this case, that is to say without the addition of resin, and the repeated heating of the stators is permissible.

In some embodiments, the return delivery takes place by way of the circulating conveyor belt. In other embodiments, a first conveyor belt is provided for conveying through the infeed region, and a second conveyor belt is provided for conveying through the return region of the transport track.

In some embodiments, the stators are transported back to the original loading location by way of the transport device, that is to say, in other words, a loading station is also configured for unloading, or loading and unloading of the stators take place at the same location.

In some embodiments, the return conveying preferably takes place in a vertically offset level, on which a further curing process takes place in an oven (also called the curing level or return conveying level in the further text).

In some embodiments, one of the deflection regions, in particular from a trickling and/or gelling level to curing and/or return conveying level, is likewise situated in the or a further oven.

In some embodiments, the rotational movement (in particular, active driving of a rotation of the stators) is dispensed with during the transfer of the stator between the levels. In particular, this is then provided if the stators are already initially gelled and the transfer takes place in or downstream of a curing region.

In some embodiments, the rotational movement (in particular, active driving of a rotation of the stators) is dispensed with in the return region, in particular in a lower level, for example curing level.

In some embodiments, the return conveying of the stators in the return region is coupled mechanically to the conveyor belt which is active in the infeed region. For example, only corresponding conducting elements are provided in the return region as, for example, on the return conveying level.

In some embodiments, the conveyor belt which is active in the infeed region is also used to roll back the stators in the return region. In particular, rollers which are arranged on the conveyor belt are also used to act on the stators for return transport.

In some embodiments, the conveyor belt is configured and arranged in such a way that it also acts on the stators at least in one of the deflection regions, with the result that, for example together with guiding elements, in particular guiding elements which form a deflection curve, it is also used for deflection. In particular, the rollers which are arranged on the conveyor belt are used for transport during the transfer between levels of the impregnation unit.

In some embodiments, the rotational movement of the stators is limited to a trickling and gelling region. Here, the “rotational movement” means, in particular, a separately driven rotational movement, that is to say not only rolling on a running surface during further cycling.

Preferred embodiments of the impregnation unit have a circulation system which has a transport device with a conveyor belt on a trickling and gelling level, which conveyor belt is configured to cycle the stators from the trickle region into the gelling region and in the process to rotate them about their own horizontally lying rotational axis at least between the trickling and gelling region, wherein deflection systems are provided at each end which are configured to cycle the stators into a further level, in particular by means of conveying elements of the transport device (more, in particular, by means of the conveyor belt), wherein the transport device is configured to cycle the stators further through the return conveying level by means of the conveying elements (in particular, by means of the conveyor belt), wherein the transport device is configured in such a way that the stators can be loaded and unloaded transversely with respect to the stator longitudinal axis without releasing clamping devices.

In accordance with a further aspect, the invention creates a trickle unit for the trickle impregnation of stators, comprising a plurality of holders in accordance with one of the preceding refinements and at least one or preferably a plurality of unit components in accordance with one of the preceding refinements. For example, the impregnation unit has at least some of the system components of trickle device, gelling device, transport device and curing device which are each provided with a rolling device for placing the rolling surfaces of the holder onto them.

The trickle unit preferably has a handling unit for loading, unloading or transferring stators which are held in the holders. In some embodiments, the handling unit is configured to grasp in each case at least one stator on its inner periphery. In some embodiments, the handling unit is configured to grip the at least one holder.

The trickle unit preferably has a conveyor belt with rolling devices which are configured for the rotational support of the at least one rolling surface of the holder, wherein the conveyor belt is configured to convey the stators which are held in the holders through a plurality of unit components which are arranged behind one another in the conveying direction.

The trickle unit preferably has a loading station which is configured for placing a group of stators which are held in the holders onto the conveyor belt in batches.

In accordance with a further aspect, the invention creates a method for the trickle impregnation of a stator which is provided with a winding, comprising the following steps:
providing a holder in accordance with one of the preceding refinements,
clamping the stator into the clamping device,
carrying out trickling and gelling on the stator which is held on the holder, wherein the holder rolls over the at least one rolling surface, in order to rotate the stator.

The method preferably comprises the use of the holder in accordance with one of the above refinements of the use. In the method, one or more unit components in accordance with one of the preceding refinements is/are preferably used.

The method is preferably carried out by means of a trickle unit in accordance with one of the preceding refinements.

Preferred refinements of the invention relate to a holder, the use of a holder of this type, and apparatus and a method for trickling stators.

Advantageous refinements of the invention make it possible to provide a method and/or an apparatus for trickling stators,
in which, during the trickling operation, the two winding head regions are freely accessible for the trickle nozzles, while the stator rotates continuously about the longitudinal axis, and/or
in which the transfer from the trickle operation to the gelling operation takes place without an interruption in the continuous rotation, and/or
in which, during gelling and while maintaining the continuous rotation, the stator is not received on the internal diameter, in order to prevent local resin accumulations on the internal diameter, and/or
which provide a solution for the problem that, since the gelling takes place predominantly in an oven at temperatures up to 200° C. and, depending on the resin which is used, the temperature can be even higher, the actuator system up to now within the oven is relatively expensive, and/or
in which receiving in the oven is carried out in a manner which is insensitive to contamination, since cleaning is always time-intensive on account of the cooling and heating times and has a negative influence on the availability, and/or
which dispense with an expensive and susceptible actuator system in the thermally curing gelling region (oven), and/or
in which, in the case of process disruptions and therefore in the case of leakage of the stator, directly affected components can be removed and cleaned simply, and/or
in which the stator is not rolled directly on the external diameter, and therefore damage on the external diameter or fracture of welded connections on the stator is avoided, and/or
in which stators can also be processed which do not have a favourable cylindrical outer contour, that is to say have local elevations and depressions such as groups, welded seams, fastening tabs, orienting lugs, etc., and/or
in which stators with different lengths and diameters/outer contours can be received without changing over the apparatus in the furnace, and/or
in which the stators can be placed very close to one another for a satisfactory utilization of the gelling region and/or the trickle region, inter-alia also for simultaneous processing of a plurality of stators as a group (or also called a batch), and/or
in which the stators are ideally arranged here transversely with respect to the longitudinal axis (stator axis), in order to make the simultaneous transport possible via a gripper/transport system which is situated along the rotational axis of the stators and continues to rotate the stators during the transport from the trickling to the gelling.

In particularly preferred refinements of the invention, a temporary receptacle (cage) is attached around the stator as a holder during the trickling and gelling.

In particular, the cage (receptacle) which is used as a holder is situated predominantly on the external diameter of the laminated stator core.

In particular, the receptacle (the cage/holder) is suitable for being received via gravity via an apparatus in the gelling region, and therefore no clamping movement or fixedly installed actuator system is necessary for the receptacle in the gelling oven.

In particular, the cage is designed in such a way that it can rotate concentrically about the longitudinal axis.

In particular, the cage and the gelling device are designed in such a way that the cage can be driven here in the gelling region.

Here, in particular, the holder does not itself have any dirt-sensitive anti-friction bearings or the like, which is disadvantageous on account of the high contamination risk due to a possible leaking stator.

In preferred refinements of the invention, this cage which serves as a holder is positioned together with the stator into the gelling region with thermal curing.

In particular, the cage which is used as a holder is placed in the gelling region onto a plurality of rollers or the like which are capable of guiding the cage in such a way that it performs a concentric rotation about the longitudinal axis (rollers, pinions, contoured wheels, toothing systems).

In particular, there is at least one roller or element which introduces the rotational movement into the cage.

In particular, the guidance of the cage and rotation is possible without an additional actuator system.

In particular, the rotational axis of the element is situated in the gelling region for guiding the cage in a different position from the rotational axis of the cage; therefore, this element does not rotate concentrically with respect to the cage.

In particular, the element for guiding and positioning the cage in the gelling region at the same time also introduces the rotational movement about the longitudinal axis into the cage.

In some embodiments, the holder which is configured, in particular, as a cage can have at least one or a plurality of the additional features/improvements explained in the following text.

In currently preferred embodiments, the stator is clamped in the cage radially via the shell surface. In some embodiments, this therefore results in no axial overhang of the cage beyond the laminated core, with the result that there is, in particular, improved nozzle access. In particular, the same clamping cage can thus also be used for different stator lengths. The principle of the radial clamping functions in the case of stators with the cylindrical outer surface (stators “without ears”) and in the case of stators with outer surfaces which deviate from a cylindrical shape (stators with ears, for example in order to provide fastening receptacles).

At least one rolling surface of the holder is configured by a resurfaced roller with a V-shaped groove, which affords advantages with regard to the lowest contamination.

In other embodiments, the stator is not clamped in the cage radially via the shell surface, but rather axially via the laminated core end surfaces by elements which due to the principle project slightly, in order to prevent fanning open of the laminated core during the gelling process, wherein this slight axial overhang does not yet have any negative influence on the accessibility of the winding heads by way of the trickle nozzles.

In some embodiments, the stator is clamped in the cage radially via a non-positive connection.

In some embodiments, the stator is clamped in the cage axially via a positively locking connection.

In some embodiments, the stator is clamped in the cage axially via a non-positive connection.

In some embodiments, the axial bracing takes place by means of screws.

In some embodiments, the axial and/or radial clamping of the laminated core takes place by means of springs, in order for it to be possible for different laminated core length/diameters and different thermal longitudinal expansions during the process to be compensated for.

In some embodiments, the cage is configured in such a way that the stator can be inserted axially or radially, without it being necessary for the elements which later brace the stator axially/radially to be dismantled.

On the external diameter or on a region which is accessible from the outside, the cage has at least one cylindrical surface for receiving in the gelling region (rolling surface). This surface can also be of conical or spherical configuration. This surface can also have a toothing system or another profile which permits a concentric rotational movement about the longitudinal axis in interaction with a corresponding mating component.

In some embodiments, there are cylindrical or substantially cylindrical surfaces (rolling surfaces) in the front region and in the rear region, which surfaces make receiving via a plurality of regions possible. These receiving surfaces (rolling surfaces) preferably have the same diameter.

In some embodiments, the cage provides two conical outer surfaces for receiving which, in particular, are arranged in a mirror-inverted manner, in order to make receiving in at least two rollers with a V-shaped groove possible.

In some embodiments, the cage has suitable receptacles on the periphery, which are suitable for a concentric rotation of the stator about the longitudinal axis by way of a corresponding mating element (roller, pinion, toothed shaft, etc.).

In some embodiments, the ends of the cage are configured in such a way that a radially inwardly directed overlap of the two end faces of the laminated stator core preferably takes place completely, and therefore the outer region or the outer ring surface of the laminated stator core end sides are covered and protected against contamination.

In some embodiments, the cage has a radial extension at its axial ends, in order possibly to allow resin which leaks from the stator during trickling to deliberately trip downwards in a certain region, preferably in a region in which no critical mechanism of the unit is situated in the gelling or trickle region, which mechanism might be contaminated by the dripping.

In some embodiments, the stator is received into the cage axially, wherein the cage is opened axially by an actuator during the joining operation, the stator is introduced into the cage in a defined angular position, is subsequently rotated by a defined angle, the cage is subsequently closed axially, and the stator is clamped in this angular position by temporarily overlapping tabs on the cage on temporary projecting elements on the laminated core in the longitudinal direction. This force-actuating opening of the cage can also take place by way of the stator and/or a gripper directly during threading into the cage.

In some embodiments, the cage is designed in such a way that the stator can be introduced axially in a defined angular position into the assembled state, and that a change in the angular position about the longitudinal axis between the stator and the cage achieves a situation where the stator is fixed in a positively locking manner in both axial directions (bayonet lock) by the cage on locally radially projecting elements. This fixing is preferably ideally by way of bracing of the cage, preferably additionally in a frictionally locking manner via a spring.

In some embodiments, the cage is designed in such a way that, during the introduction of the stator into the cage, the latter is at the same time opened axially and, after a rotation of the stator about the longitudinal axis of the cage or a rotation of the cage about the longitudinal axis of the stator, it is then clamped axially between locally projecting elements on the laminated stator core.

In some embodiments, the cage is of multiple-part configuration if it is, for example, a laminated stator core with a cylindrical outer surface, or has other features of higher priorities such as:
the end surfaces on the laminated core are covered as far as possible by the cage or elements on the cage, in order that contamination of this outer end surface region on the laminated core is prevented, in order to make reliable sealing of subsequent attachment elements or clean screen surfaces is possible.
this temporarily axially applied protective element of the cage for protection against contamination can be configured in such a way that, in the case of a leaking stator, the rolling surfaces of the cage and the associated mating rolling partners in the gelling region are not contaminated by the resin, but rather it is diverted, for example, downwards into a drip pan. This can be achieved, for example, by way of targeted drip edges on this protective element.

In some embodiments, the cage is configured in such a way that it can receive stators of different lengths. This takes place, in particular, by radial clamping in (without axial clamping in) or, in the case of axial clamping in, by way of adaptation of the cage length by spring preload and longitudinal guides.

In some embodiments, the cage is designed in such a way that a stator can be introduced axially and fixed by temporarily inwardly protruding elements at the axial end of the cage being pivoted away or removed.

In some embodiments, the holder has features for direct gripping of the holder, configured in particular as a cage, by means of a gripper for loading and unloading the gelling station. In this way, for transfer purposes, the stator does not necessarily have to be gripped by means of an internal gripper (which necessitates the risk/disadvantage of the contamination of the gripping jaws). For example, a counterpiece which is complementary with respect to a gripper can be provided on the holder, or projections and/or recesses are provided, on which a gripper can act in a positively locking and/or frictionally locking manner, in order to gripper the holder including the stator.

In some embodiments, the holder, configured in particular as a cage, is designed in such a way that it can be deposited rotationally into a further device without positional orientation.

In preferred embodiments, the holder, preferably configured as a cage, can also be used for mounting in the trickle region.

In some embodiments, the stator and/or cage are/is not received by the same rotational device during gelling and during trickling, but rather are/is transferred by a handling unit between trickling and gelling.

In some embodiments, features of the holder which is preferably configured as a cage, in particular its rolling surface or surfaces, are also used in the trickle region, in order to rotate it or the stator about the longitudinal axis via the same or a further guide device, wherein the mounting elements of the guide device do not rotate concentrically about the stator in the region for trickling.

In some embodiments, the holder will which is configured, in particular, as a cage is substantially rotationally symmetrical.

In some embodiments, the stator is fixed substantially concentrically in the holder which is configured, in particular, as a cage.

In some embodiments, the holder which is configured, in particular, as a cage is configured to receive a stator which is substantially not round on the external diameter and is therefore not suitable for it to be rotated concentrically about the longitudinal axis directly via suitable elements.

In some embodiments, the holder which is configured, in particular, as a cage is configured in such a way that it can receive segmented radial overhangs from the laminated stator core, and the stator is clamped on the laminated core via these regional radial overhangs. These radial overhangs on the laminated stator core are usually fastening tabs of the stator, by way of which the stator is subsequently mounted in a housing. In some embodiments, the holder is configured to clamp the stator at these fastening tabs or segment-shaped radial elevations axially in the holder, in particular the cage. For example, these tabs extend continuously over the complete axial length of the laminated stator core; for a case of this type, it is provided in some embodiments that the cage extends slightly beyond the axial ends of the laminated core for axial clamping in via these tabs.

In some embodiments, the holder which is configured, in particular, as a cage is designed in such a way that it can be gripped rotationally via a gripping apparatus and can be transported from the trickle station to the gelling station without interruption of the rotation.

In some embodiments, the cage is only temporarily fixed on the stator in an uninterrupted manner in order to trickle the stator and subsequently gel/cure the stator.

The stator is preferably driven in rotation via the cage centrally with respect to the longitudinal axis and held in position at least during the gelling process.

In preferred refinements, a rolling device is provided as receptacle for the holder in the gelling region of a trickle unit (in the gelling device), on which rolling device the holder can be placed with its rolling surface.

In preferred embodiments, this receptacle which is configured as a rolling device in the gelling device has one or more features or improvements which are explained in the following text.

In some embodiments, the holder which is configured, in particular, as a cage is received via for rollers which are situated in the rear and front region, in each case to between 3 and 6 o'clock and to between 6 o'clock and 9 o'clock.

In some embodiments, at least one of these rollers has a flanged disc, that is to say an elevation of the diameter on one side, in order to make axial positioning of the rotating holder/cage possible.

In some embodiments, a running surface of the holder (in particular of the cage) is configured for receiving into a roller, for example, with a V-shaped groove for accurate axial positioning.

In some embodiments, in the case of a plurality of rollers arranged in the longitudinal direction, they ideally lie behind one another, in order to be received by a common shaft.

In some embodiments, the rollers which lie behind one another have the same diameter; therefore, these rollers can be connected to a rigid shaft.

In some embodiments, all the guide rollers are actively driven, in order for it to be possible for a rotational stop to be ruled out in the case of, for example, a stiff roller.

In some embodiments, the shaft, on which the at least two rollers for receiving the stator are situated, are driven jointly, and are connected to one another, for example, via a chain.

In some embodiments, the shafts with bearing and pinion are designed in such a way that they can be dismantled rapidly for cleaning purposes.

In some embodiments, the shafts with bearings are designed by means of deflector discs in such a way that a leaking stator can leak only over the shafts and not over the bearing, by the bearing being situated in each case offset axially forwards and rearwards.

In some embodiments, the shafts are situated with guide rollers above the stator center point (stator axis), and the stator is held from above by means of magnetic force (magnetic rollers), and a contamination of the bearing is therefore not possible.

In some embodiments, guide plates which, in the case of a disruption, guide the resin away from the roller receptacle are situated on the cage on the end side in a targeted manner.

Instead of or in addition to the gelling region, the described receptacle, configured as a rolling device, for the holder can also be used for the trickle region (in the trickle device), since the rollers/receptacles and shafts are always situated below the center point and always further away in terms of radius than the greatest radius in the winding head, and therefore do not collide with the trickle nozzles.

In preferred refinements, it can therefore be avoided that the stator does not have to be gripped in the internal diameter during trickling, during transfer and during gelling, and therefore no clamping jaws are contaminated, and no undesired deposits/resin accumulations occur on the internal diameter as a result of the clamping jaws.

Preferred refinements also relate to a rolling device for a unit component of an impregnation unit, which rolling device is designed in such a way that it can receive a preferably substantially rotationally symmetrical holder (in particular, configured as a cage) with a substantially concentrically clamped-in stator, wherein the cage is situated on the outer periphery of the laminated stator core and this cage is not axially longer or is slightly axially longer for receiving purposes than the laminated stator core, and can symmetrically rotated about the longitudinal axis, and at the same time has only locally a greater radius about the rotational axis than the cage or the stator itself.

In some embodiments, this segment for receiving the holder which is configured, in particular, as a cage in the rolling device which extends radially to a greater extent than the cage or the stator itself does not also rotate during the rotation and is therefore situated at the same location during the rotation of the stator.

In some embodiments, the rolling device has only one actuator for the rotation of the stator, and no actuator for actively clamping or fixing the holder/cage or the stator.

In some embodiments, the rolling device itself preferably has rotating or moving parts which can rotate and position a substantially rotationally symmetrical cage concentrically.

In some embodiments, the rolling device is configured in such a way that a rotationally symmetrical cage can be transferred without position orientation and, for example during receiving, no toothing system, etc. has to interlock in a targeted manner. No claw couplings, three-jaw chucks, etc. which require corresponding positional orientation are advantageously provided either.

In some embodiments of the rolling device, these rollers have a cylindrical, spherical or conical outer surface.

In some embodiments, these rollers have a defined contour which enable a concentric rotation about the longitudinal axis in conjunction with a corresponding negative contour in the cage (pinion, toothing system, belt).

In some embodiments, these elements are preferably attached in the lower half from the rotational center point, in order therefore to also use gravitational force in order to fix the cage on the rollers.

In some embodiments, the elements can also be attached above the rotational center point, and a connection to the elements can be established, for example, by means of a magnet.

In some embodiments, the rolling device preferably receives the holder, configured in particular as a cage, via rollers, wherein in each case two rollers are arranged in the left-hand lower region and two rollers are arranged in the right-hand lower region, and are each seated on a common shaft.

In some embodiments, the left-hand and right-hand shaft are driven via a common chain.

In some embodiments, a plurality of shafts for receiving a plurality of holders which are configured, in particular, as cages are driven by the chain.

In some embodiments, the shaft with at least one roller assumes at the same time the guidance/receiving of a holder which is arranged on the left and the holder which is arranged on the right which are configured, in particular, as a cage.

In some embodiments, the rolling device is designed to receive a plurality of cages at the same time.

In some embodiments, the rolling device is configured as a circulation system with a chain, in particular in such a way that the stator/holder (cage) can be placed in a region rotationally between the trickling and gelling station and can return any other region in a stationary or not actively rotating manner.

In some embodiments, the holder (cage) and the stator are rotated continuously about the longitudinal axis without interruption from the start of trickling to the end of gelling.

In some embodiments, the unit component is configured in such a way that the stator/cage can be loaded purely radially. The stators can be loaded purely by the movement transversely with respect to the stator axis into the unit component, in particular can be placed on a rolling device.

The stator/cage advantageously does not have to be clamped fixedly to the circulation system, but rather is transported via rollers/rolls which are rotatable as described above.

The holder which is configured, in particular, as a cage with a liftable receptacle, preferably configured as a rolling device and more preferably comprising rollers/rolls, can preferably be lifted from below.

In some embodiments, this receptacle which can be lifted can in each case move in between the rollers/rolls of a rolling device with a transport device and another unit component.

In some embodiments, this receptacle which can be lifted is configured to lift and deposit again the holder which is configured, in particular, as a cage, both in a rotational manner and also in a non-rotational manner.

In some embodiments, the receptacle which can be lifted is assigned to the trickle device. The rotational axis of the holder/cage or the stator is preferably predominantly horizontal here on the receptacle which can be lifted, with possible intentional slight inclinations of the rollers/rolls during the trickling.

Some embodiments also relate to a trickle unit with an associated method, which trickle unit has a trickle region (arranged in a trickle device), a gelling region (arranged in a gelling device), and a transport device, wherein the trickle device is configured, in the case of a stator, to trickle the winding heads on the two axial ends with liquid resin, while this stator rotates about its own axis. In particular, during the trickling process, the stator is not clamped on the internal diameter, in order to avoid contamination of the jaws and resin accumulations in the internal diameter. In particular, the stator is transported via the transport device from the trickle region into the gelling region, wherein the stator carries out a rotation about its own axis without interruption during the transport from the trickle region to the gelling region, wherein the stator is rotated further about its axis in the gelling region until the resin is initially gelled, and wherein a further stator can already be trickled in the trickle region during the rotating initial gelling procedure in the gelling region, wherein the rotation is never interrupted for every stator from “start, trickling” to “end, gelling”, and the trickle region and the gelling region are situated at spatially different positions.

Here, the “end, gelling” is defined in such a way that the originally liquid resin has initially gelled or cured to a correspondingly pronounced extent and/or the viscosity has become so high that the rotation about the longitudinal axis can be dispensed with for the further curing process.

In the following text, preferred features and advantages of the gelling region in some preferred embodiments will be explained.

In some embodiments, the gelling station is a convection oven. In some embodiments, the gelling station has an induction coil. In some embodiments, the gelling station is stationary, that is to say the stator is transported to the gelling station, and the gelling is not carried out at the same location as the trickling. In some embodiments, the gelling station is designed as a continuous oven, and the stator is cycled through. In some embodiments, the gelling or the curing takes place via temperature. In some embodiments, the gelling of the curing takes place via time, for example in the case of two-component resins. In some embodiments, the stator is not clamped by the internal diameter in the gelling region either.

In the following text, some features and advantages of preferred embodiments of the trickle unit in accordance with preferred refinements of the invention will be explained in greater detail.

In some embodiments, the stator is cured further after the initial gelling. In some embodiments, the rotation is dispensed with in the curing region. In some embodiments, the trickle unit additionally comprises the curing temperature via temperature. In some embodiments, the trickle unit additionally has an upstream preheating process (preheating device) for preheating the stators, wherein this preheating further preferably takes place via convection or else via induction.

In the following text, some features and advantages of preferred embodiments of the transport device in accordance with preferred refinements of the invention will be explained in greater detail.

In some embodiments, the transport device has a gripper, by way of which the stator is gripped on the inside for transport. In some embodiments, the stator is not gripped on the inside by way of a gripper for transport, but rather on the outer surface. In some embodiments, the stator is not gripped directly for transport, but rather a temporarily mounted holder is gripped for transport, in particular the holder with the rolling surface and more particularly configured as a cage. In some embodiments, the gripper is designed for transport in such a way that only the stator, or the arrangement comprising the stator and the cage, or else only the cage on its own can be gripped and transported. In some embodiments, the gripper is designed for the stator in such a way that it can also remove the stator from the holder or cage, wherein this preferably takes place after the gelling or later, or else for introducing the stator into the holder or cage at least before the trickling. In some embodiments, the gripper is configured for introducing the stator into the holder which is configured, in particular, as a cage or for removing the stator from the holder which is configured, in particular, as a cage, in such a way that the stator can be rotated relative to the cage (bayonet lock). In some embodiments, the gripper is configured in such a way that a cage which is configured for clamping in axially can be pushed as a holder axially over the stator. In some embodiments, the gripper or the gripping system can be moved via a robot or via a linear gantry. In some embodiments, the transport device has, as transport system, a conveyor belt which transports the stator further in a rotational manner. In some embodiments, the conveyor belt has a temperature-resistant configuration. In particular, the conveyor belt is configured to convey the components directly through the oven, for example by way of a chain. In some embodiments, the transport device is configured, in order to convey the component, to place it on the outer side on the conveyor belt on elements which can further rotate the component during the transport, for example on rollers. In some embodiments, the stator is either guided and rotated directly via its cylindrical outer surface on the conveyor belt, or a cage which is mounted as a holder is guided and rotated indirectly on the stator via an outer surface on the conveyor belt. In some embodiments, the rotational movement is transmitted into the component here directly by rotation of the support rollers. In some embodiments, the rotational movement is introduced into the component via a mounted pinion on the component and/or a further conveyor chain.

In the following text, preferred features and advantages of the trickle region or the trickle device in preferred refinements of the invention will be explained in greater detail.

In some embodiments, the stator is received directly on the outer shell surface or via the external diameter of a workpiece receptacle (holder) mounted beforehand, preferably configured as a cage.

In some embodiments, a receptacle for the stator in the trickle region is designed in such a way that the stator can be received directly, or a stator mounted beforehand in the cage can be received in such a way that the associated clamping mechanism or receiving mechanism or else actuator system does not rotate with it. In some embodiments, the stator is received in the trickle region via a cage which is mounted beforehand and is not connected fixedly to the receptacle for the stator in the trickle region. In this way, the cage can be fed with the stator to the trickle region and can be removed, for example, for cleaning purposes. The cage or the parts which come into contact with the workpiece can be cleaned in a separate region in a manner which is parallel to the cycle time. In some embodiments, the stator can be additionally swivelled about the transverse axis in at least one direction or even in both directions. In some embodiments, the stator in the trickle region can be trickled on the inside and the outside at the two winding heads. In some embodiments, a trickle nozzle and the associated axes (in the context of movement actuators) are designed in such a way that the nozzle can trickle the winding heads on both sides of the stator. In some embodiments, all the trickle nozzles and the associated axes are designed in such a way that all the nozzles can trickle the winding head on both sides. In some embodiments, the stator is received in the trickle region via the round external diameter of the stator or via the external diameter of the mounted cage. In some embodiments, a receptacle, configured in particular as a rolling device, for the stator in the trickle region is designed in such a way that the cage in the trickle region is rolled on rollers which are arranged below the center, and lies on these rollers predominantly due to gravity. In some embodiments, the receptacle is designed in such a way that the cage is driven via the rollers, on which the cage or the stator lies. In some embodiments, the receptacle is designed in such a way that the cage in the trickle region is rolled on rollers which are arranged above the center, and is pressed onto the rollers counter to gravity by an additional force such as, for example, via a magnet in the upper region. In some embodiments, the introduction of the rotation of the stator during trickling takes place via the rollers. In some embodiments, the introduction of the rotation of the stator takes place via an additional drive element (in particular, (endless) traction mechanisms such as a belt or a chain or cable) which wraps around a certain angular region of the cage or stator on the outer surface, and therefore transmits the necessary forceful rotation via a frictionally locking connection or else a positively locking connection. In some embodiments, the stator is lifted from the transport system during trickling, in order to provide a temporary collection trough for possible dripping of the resin between the stator and the transport system and therefore to avoid contamination of the transport system.

In the following text, particular features or advantages of the stator which is to be handled in preferred refinements of the invention (in particular, its possible designs) will be explained in greater detail.

In some embodiments, the stator can be substantially round on the laminated core outer surface, and is received directly via this external diameter in the trickle region and/or gelling region. In some embodiments, the stator can have, on the laminated core outer surface, elevated regions which are suitable for axial receiving in a clamping cage, by the stator being clamped axially into the cage via these radially projecting regions, wherein the cage is further preferably designed in such a way that, in order to join the stator into the cage, the latter merely has to be open counter to a spring force. In some embodiments, the stator can be clamped radially in the holder or cage. In some embodiments, the stator can be clamped axially via the end surfaces in the holder or cage.

With the aid of some particularly preferred refinements of the invention, it is possible to dispense with the internal clamping, in order thus to avoid unacceptable resin accumulations on the internal diameter. At the same time, inexpensive large-volume unit technology is possible, since the stator can be rearranged between the trickle station and the gelling station, and therefore the next stator can already be trickled while the first stator is still being gelled. In addition, stators with a different external design can be produced in the same unit; synchronization during the movement of the stator from the trickle region into the gelling region is not required either. A further advantage is the modular construction as a result of the transfer of the stator, since a disruption in a synchronized system (for example, chain belt) leads directly to a failure of the complete unit, as a result of which a reduced production can be maintained here in a modular system by means of transfer by way of a gripper. A further advantage of preferred refinements of the invention is the inexpensive and robust mounting or receiving in the trickle region and gelling region. Preferred refinements of the invention make a robust resin-insensitive construction possible in the gelling region, where leaking of the stator as possible. In particular, necessary guides with narrow tolerances and guides which can be sealed unsatisfactorily such as longitudinal guides in the three-jaw chuck are avoided. Preferred refinements also make it possible to dispense with an additional activation actuating system.

A three-jaw chuck which is installed fixedly in a chain can be replaced only in a time-intensive manner, since this is a heavy component which first of all has to be cooled, and is often mounted at great heights and is poorly accessible. In contrast, shafts, onto which the stator is placed and which are driven, for example, via a pinion can be exchanged very rapidly on account of a low weight and without an actuator system, if required even without cooling of the component.

### BRIEF DESCRIPTION OF THE DRAWINGS

Exemplary embodiments of the invention will be explained in greater detail in the following text on the basis of the appended drawings, in which:

FIG. 1 shows a section through a stator which is held on an internal clamping unit, in order to explain trickle impregnation,

FIG. 2 shows an enlarged detail from FIG. 1,

FIG. 3 shows an axial plan view of a stator which is situated in the trickle region of the trickle unit, in order to clarify the ideal positioning of trickle nozzles in the case of one embodiment of a method for trickle impregnation,

FIG. 4 shows the section along the line A-A from FIG. 3, in order to clarify the ideal position of trickle nozzles,

FIG. 5 shows an enlarged detail from FIG. 4,

FIG. 6 shows a section along an axial plane through a stator which is in a swivelled state in a trickle region, in the case of one embodiment of a method for trickle impregnation,

FIG. 7 shows a side view of the stator in the situation from FIG. 6,

FIGS. 8a, 8b show views as in FIG. 6, wherein the trickling by way of two trickle nozzles in both swivelling directions is shown,

FIG. 9 shows a diagrammatic front view as overview illustration of one preferred embodiment of a trickle unit with a plurality of unit components including a conveying unit, configured as a circulating system, of a transport device,

FIG. 10 shows a plan view of the conveying unit of the transport device of the trickle unit from above in FIG. 9,

FIG. 11 shows the front view of the trickle unit from FIG. 9, wherein an oven and different functional regions thereof are additionally shown,

FIG. 12 shows a side view from the right in FIG. 9 of a stator which is held in a holder in accordance with a first embodiment and is transported on the transport device, together with the rolling device of a unit component, onto which the holder is placed,

FIG. 13 shows a front view of the arrangement which is shown in FIG. 12, as viewed from the left in FIG. 12,

FIGS. 14a to 14c show side views of an arrangement of two adjacent holders with a stator on the rolling device according to FIGS. 12 and 13 together with the rolling device, configured as a lifting device, of a further unit component, in particular a trickle device, at different stages of the lifting of the holders with stators,

FIGS. 15a to 15c show the situations of FIGS. 14a to 14c in a front view, as viewed in each case from the left in FIGS. 14a to 14c,

FIGS. 16a to 16c show side views as in FIGS. 14a to 14c, wherein three stages which follow the situation from FIG. 14c during trickling of the stators are shown, which stators are lifted from a trickle region of the trickle unit by way of the rolling device which is configured as a lifting device, and are swivelled for trickling,

FIG. 17 shows a plan view of a further embodiment of the conveying unit of the transport device during four stages which follow one another and are shown below one another,

FIG. 18 shows a front view of a further embodiment of the trickle unit with a further embodiment of the transport device,

FIGS. 19a to 19f show front views of a region of a further embodiment of the trickle unit with a rolling device, configured as a lifting device, on the trickle region during six stages of the method which follow one another,

FIG. 20 shows the detail XX from FIG. 19c,

FIG. 21 shows a sectional illustration through one specific embodiment of a trickle unit,

FIG. 22 shows a plan view of the trickle unit from FIG. 21,

FIG. 23 shows a perspective isometric view of the trickle unit from FIGS. 21 and 22,

FIG. 24 shows a perspective view of a first embodiment of a holder which is configured, in particular, as a cage,

FIG. 25 shows a diagrammatic side view of the holder from FIG. 24 with a clamped-in stator,

FIG. 26 shows a perspective view of one variant of the first embodiment of the holder,

FIG. 27 shows a diagrammatic side view of the holder from FIG. 26 with a clamped-in stator,

FIG. 28 shows a side view of a second embodiment of the holder,

FIG. 29 shows a perspective view of the holder from FIG. 28,

FIG. 30 shows a side view of the holder from FIG. 28, wherein a shorter stator is clamped in,

FIG. 31 shows a side view of the holder from FIG. 28, wherein along the stator is clamped in,

FIG. 32 shows a perspective view of a holder in accordance with a further embodiment,

FIGS. 33a to 33c show views of mounting a stator in a holder in accordance with one of the embodiments of FIGS. 24 to 32,

FIG. 34 shows a perspective view of a currently preferred further embodiment of the holder, wherein a stator which is clamped into it, for example, is indicated using dashed lines,

FIG. 35 shows a side view of the holder from FIG. 34 with an indicated stator together with a matching embodiment of the rolling device of one of the unit components of the trickle unit,

FIGS. 36a to 36d show perspective views of a further embodiment of a trickle unit during different stages of the method, which can be carried out by way of it, for trickle impregnation,

FIG. 37 shows a perspective view of one example of a rolling device of the unit component of the trickle unit from FIGS. 36a-36d,

FIG. 38 shows a plan view of the rolling device from FIG. 37, and

FIGS. 39a and 39b show side views of the rolling device in different swivelling positions.

### DETAILED DESCRIPTION OF THE PREFERRED EMBODIMENTS

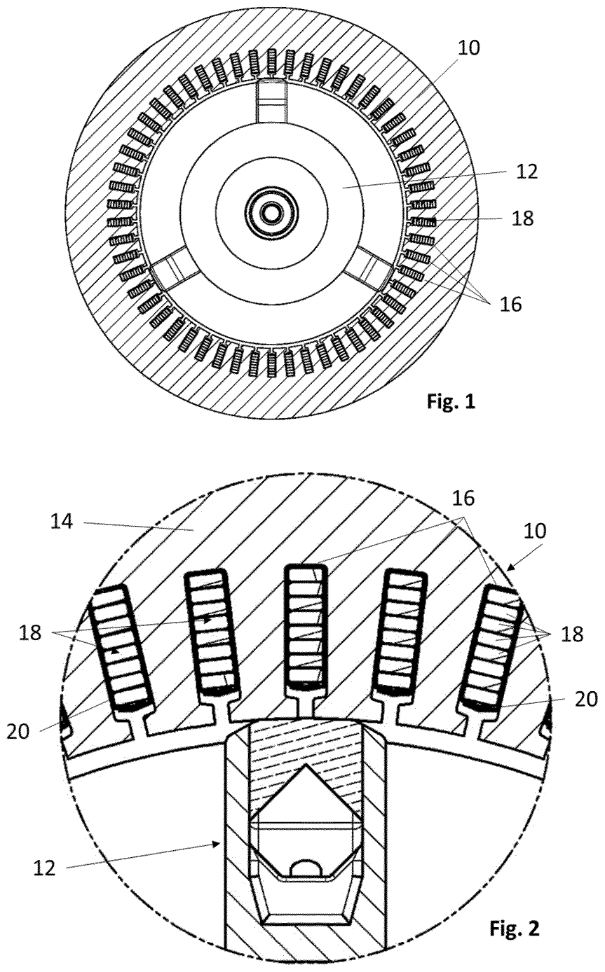

In the following text, advantageous measures for trickle impregnation of stators 10 will first of all be explained on the basis of FIGS. 1 to 8b.

FIG. 1 shows a sectional illustration through a stator 10 which is clamped in or on an internal clamping unit 12. The stator 10 has a laminated core 14 with a series of inwardly opening grooves 16, in which wires of a coil winding 18 are inserted. As can be gathered from FIG. 2 which shows an enlarged detail from FIG. 1, the wires in the respective grooves 16 are surrounded by an insulation, for example insulating paper 20.

During the production of stators 10, in particular in the case of stators 10 for a traction drive, it is also routine (see the citations mentioned at the outset), inter alia, that a winding 18 of the stator 10 is impregnated with a resin. Resins which cure via temperature are customary here, or else two-component resins. Polyester resins, polyesterimide resins or epoxy resins are customary. The application of the resins onto or into the winding 18 in the stator can also take place by the dip method, rolling method or else trickle method. Here, the stators 10 can result from a very wide variety of winding methods; in particular, the winding 18 is a flat wire winding (also called a hairpin or wave winding) or a round wire winding as is customary, for example, in pulling-in technology. In the case of stators of from 48 V up to over 1000 V, an additional insulation (often configured as an insulating paper 20) is usually situated between the winding 18 and the laminated core 14.

In the case of internal rotor machines and their stators 10, into which the winding 18 is usually introduced by way of inwardly open grooves 16, the trickle method has the substantial advantage in comparison with the other methods that the contamination of the external diameter or the end sides can be avoided, and therefore laborious subsequent cleaning of these surfaces can be dispensed with.

A contamination of the external diameter and the end surfaces 30 can be critical, since the external diameter often serves as a functional surface. For example, the stator 10 is often shrink-fitted into a housing in the further course of assembly. A contamination is undesired on the end surfaces 30, since the stators 10 are usually screwed axially on to a housing, or additional functional parts such as, for example, elements for cooling the stator 10 are attached to these end surfaces 30, and therefore a contaminated surface can lead to functional disruptions such as leaks.

No layer structure is also desired on the internal diameter, since the inner rotor is often configured with a very small gap to the stator 10 in internal rotor motors of this type, in order to achieve as high degree of efficiency as possible.

If, as mentioned, a contamination of the external diameter, of the internal diameter and of the end surfaces 30 is undesired, but a resin impregnation of the winding 18 is nevertheless required, the trickle method has the abovementioned advantage in comparison with the other methods.

In the case of stators 10 with a high degree of efficiency and/or high performance and/or high oscillations during operation, the impregnation of the winding 18 cannot be dispensed with. During the impregnation, the intermediate spaces in the grooves 16, which are present due to the process between the winding 18, possibly the groove insulation (for example, insulating paper 20) and a laminated core 14, are potted with resin. This additional often indispensable step improves, for example, the thermal conductivity between the winding 18 and the laminated core 14, as a result of which the heat dissipation is improved and, as a result, the unit becomes more powerful. A further advantage of the impregnation is the fixing of the winding 18, in order, in the case of oscillations, to avoid a relative movement of the winding 18 with respect to the laminated core 14 and therefore damage of the installation of the winding 18. A further advantage is the additional insulation of the winding 18 by the resin, which permits higher voltages in the winding 18 which make the unit more powerful.

It can generally be stated that an impregnation of the winding 18 affords a very large number of advantages for electric drives or generators with high performance and degrees of efficiency. Special advantages result if a contamination of the internal diameter, external diameter and also end surfaces of the laminated core 14 are avoided as far as possible.

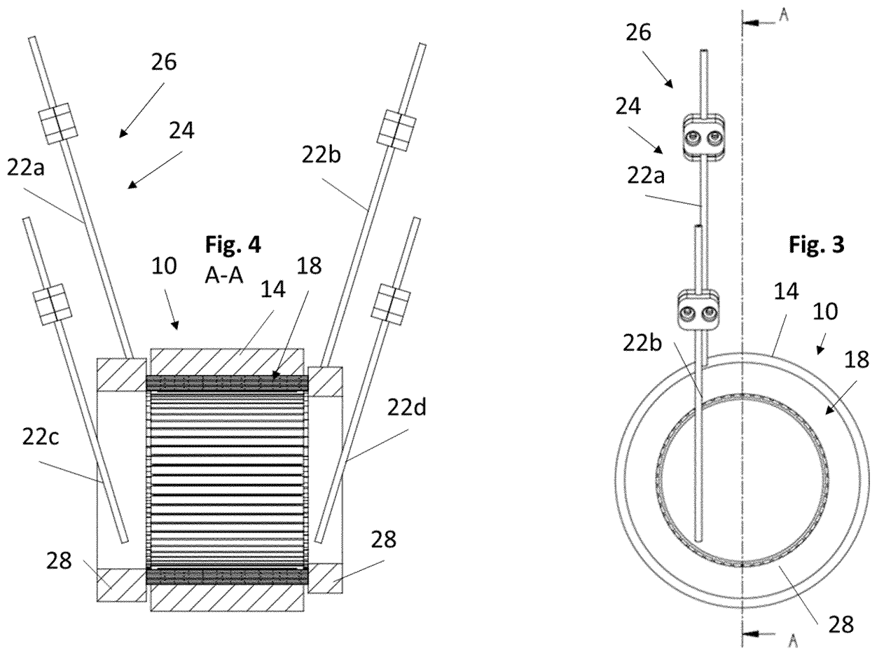

FIGS. 3 and 4 show particularly highly suitable positions of trickle nozzles 22a-22d in the case of trickle impregnation in accordance with advantageous refinements of a trickle method and a trickle device 24 which can be part of a trickle unit 26.

In the case of the trickle method, the resin is as a rule trickled onto the projecting winding 18, and the resin runs, assisted by the capillary action, into the grooves 16 of the stator 10; at the same time, the stator 10 is rotated continuously about a rotational axis which as a rule coincides with the stator axis (stator longitudinal axis, defines the subsequent rotational axis of the electric machine which is provided with the stator).

In the case of the trickle method, the stator 10 is as a rule heated before the application of the resin to a temperature which is normally lower than the curing temperature of the resin, usually between 100° and 130° C., depending on the resin. In some embodiments, the impregnation resins used for the stators 10 have a substantially lower viscosity at somewhat higher temperatures; as a result, the capillary action of the resin during the trickle operation is improved.

The maximum possible dosing speed depends on the stator design; that is to say, only as much should be dosed as is drawn into the grooves 16 at this time on account of the capillary action. If the dosing quantity is too high, resin also flows onto the end surfaces of the stator 10, which is undesired.

Therefore, a trickle operation of this type can last several minutes, depending on the stator design and the stator size.

At the abovementioned higher temperatures for the capillary action which is improved as a result, however, the resin begins to gel, that is to say to cure, after a certain time; therefore, the trickle operation should not take too long. Therefore, resin is usually dosed onto the winding 18 at the two ends of the winding 18 (also called winding head 28) by way of the dosing needle (example for trickle needle 22a-22d), with the result that resin can be drawn into the grooves 16 at the same time from both sides of the stator 10. In order to reduce the process time, it can also be advantageous for the resin to be applied to the winding head 28 by way of a plurality of dosing needles.

In the case of certain stator designs such as, for example, in the case of an inwardly closed groove insulation, undesired air inclusions can occur, however, in the case of simultaneous trickling from both stator sides. In cases of this type, trickling from one side is to be preferred, in particular in combination with slight swivelling of the rotational axis of the stator 10 with respect to the horizontal in order to assist drawing in of the resin due to gravity.

This swivelling of the stator 10 should take place only temporarily, however, since otherwise the resin runs out of the groove 16 again on the other side due to gravity; subsequently, the rotational axis of the stator 10 should be moved into the horizontal again. Some exemplary swivelling positions of the stator 10 are shown in FIGS. 6, 7, 8a and 8b.

In the case of relatively large stators 10 (and therefore a relatively large groove depth in the laminated core 14), it is often advantageous that the resin is applied not only to the external diameter on the winding head 28 close to the laminated core 14, but rather also on the inner side of the laminated core (see FIGS. 4, 6, 7, 8a and 8b).

This effect is particularly present in the case of stators with flat wire winding if the flat wire of the winding 18 fills the entire groove width, that is to say the flat wire has almost the groove which and therefore impedes the flow of resin transversely with respect to the wire direction. It is to be mentioned here that an attempt is generally made in the case of stators 10 with a high degree of efficiency to design the copper filling degree in the grooves 16 to be as high as possible. In the case of windings 18 with a round wire, there are sufficient cavities in the grooves 16, in order that the resin can propagate in all directions. In the case of windings 18 with a flat wire where all the flat wires are usually oriented axially and, in the ideal case, fill the groove 16 completely in the width and in the height, only tolerance-induced gaps remain in principle between the conductors and the region of the corner radii of the conductors. In the case of stators 10 of this type, the resin can run in the longitudinal direction into the interior of the stator 10 on account of the conductor corner radii, but a transverse flow of the resin is greatly restricted.

It is therefore often advantageous, in particular in the case of stators 10 with a flat wire winding, that trickling is carried out on one side of the stator 10 on the external diameter and on the internal diameter. This can take place at the same time, for example, by way of a first and the second trickle nozzle 22a, 22b, or by way of a single movable trickle nozzle 22a which trickles alternately on the external and internal diameter.

Depending on the stator design, it can be advantageous that trickling is carried out even on both sides of the stator 10 in each case on the internal diameter and on the external diameter.

It is to be ensured during the positioning of the dosing needle that, during the dosing, the resin as far as possible does not spray onto the end side of the laminated core 14 which can take place, for example, in the case of small air inclusions in the resin. Therefore, in the ideal case, the dosing needle is not directed against the laminated core 14, but rather as far as possible parallel to the laminated core end surface 30, that is to say as far as possible radially and therefore at a right angle with respect to the winding 18.

In order to achieve a high filling degree of resin as possible without dripping of a resin from the winding head 28, the resin should be dosed as close to the groove opening as possible, that is to say at only a very small spacing from the laminated core 14.

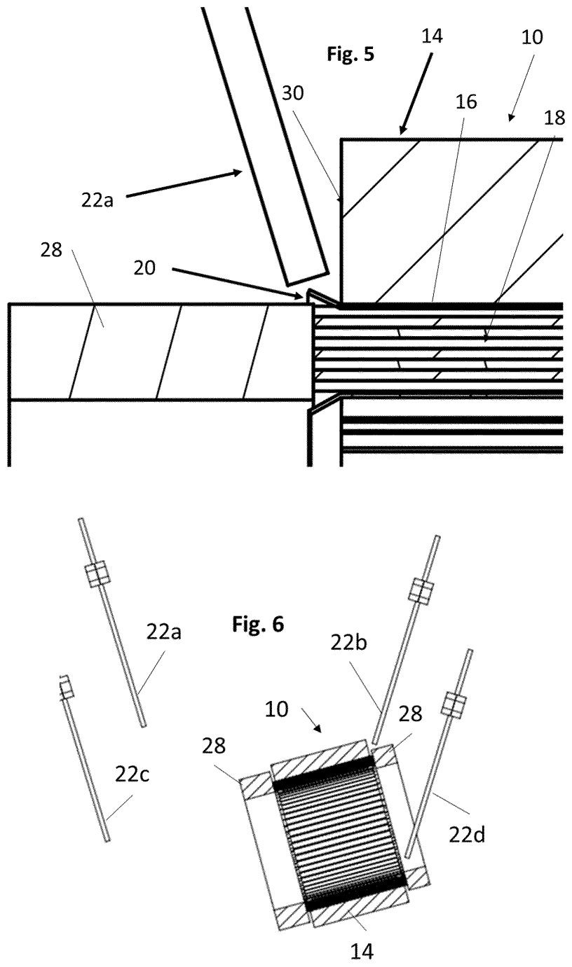

It proves advantageous here if the resin which is to fill the intermediate spaces of the winding 18 and the groove insulation (for example, insulating paper 20) is trickled directly in front of the groove insulation into the gap between the groove insulation and the winding 18, as is shown in FIG. 5. Here, the groove insulation such as, for example, the groove insulating paper 20 usually protrudes in stators 10 of this type by between 1 mm and 7 mm beyond the end surface 30 of the laminated core 14.

Here, the angle of the nozzle tip is ideally adapted in each case in a manner dependent on the winding cop side, in order for it to be possible to perform trickling onto these points, or, as shown in FIGS. 6, 7, 8a and 8b and already described above, the stator 10 is temporarily tilted, which also brings about the corresponding change in the angle between the trickle nozzle 22a-22d and the end surface 30 of the laminated core 14.

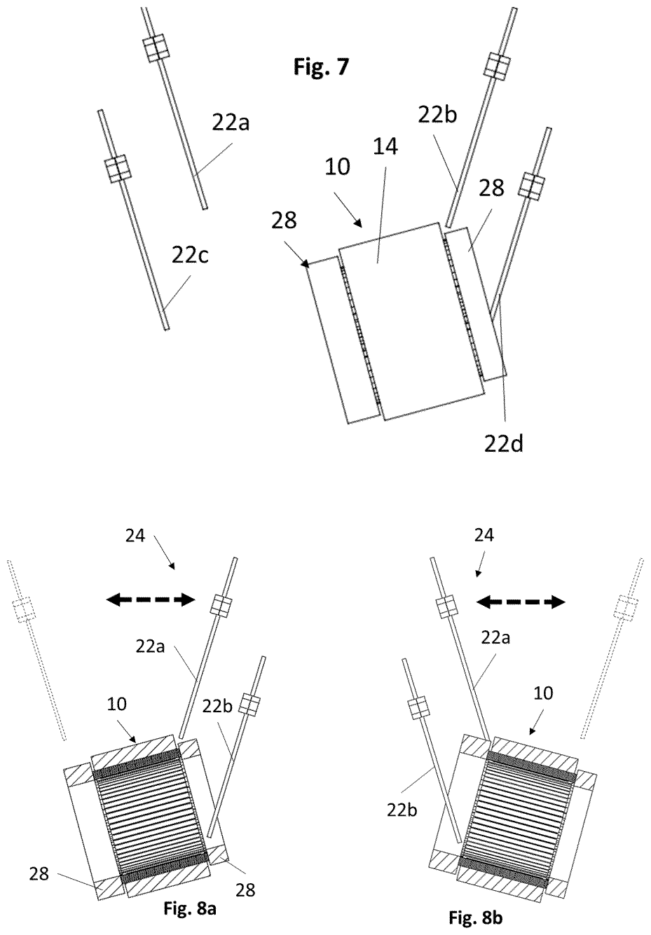

Here, FIGS. 6 and 7 show the trickling by way of the first to fourth trickle nozzle 22a-22d in a first swivelled state. FIGS. 8a and 8b show a further embodiment with only two trickle nozzles 22a, 22b which are moved toward the one or the other side of the stator 10, wherein the stator is swivelled in the first swivelling direction in FIG. 8a and in the second swivelling direction in FIG. 8b.

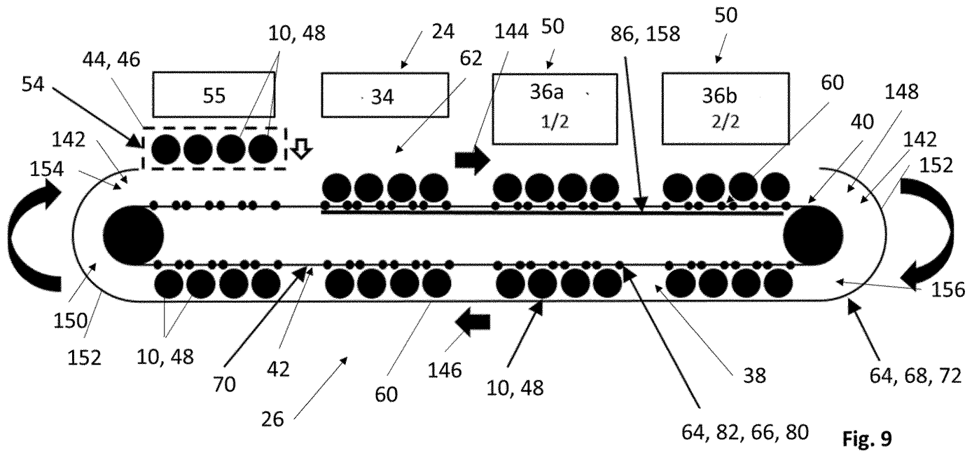

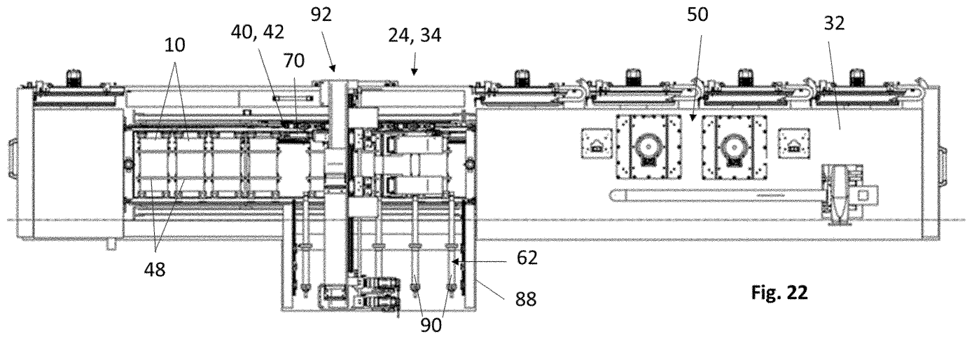

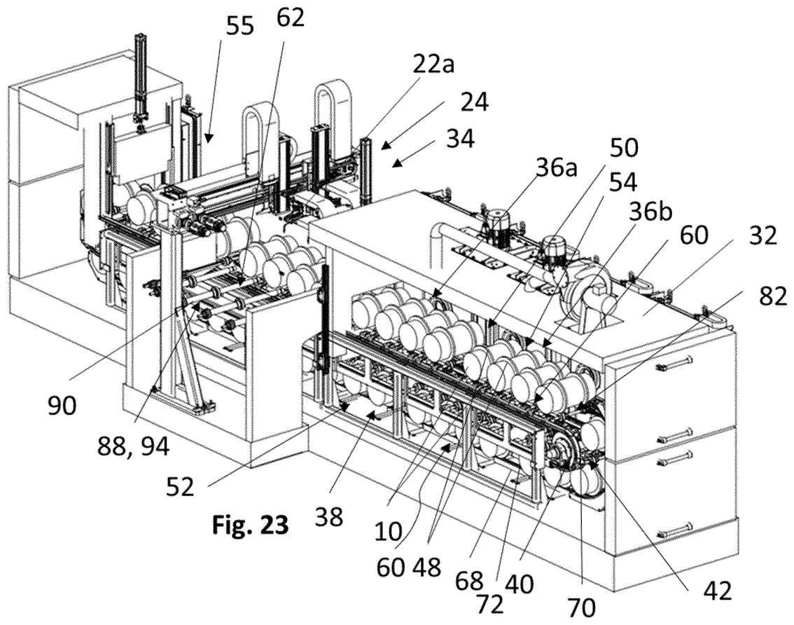

In the following text, preferred refinements of the trickle unit 26 are explained in greater detail on the basis of the illustration in FIGS. 9 to 23 and 36a-39b.

After the trickling, the resin in the stator 10 is gelled with continuous rotation (beginning of the curing) and is subsequently cured completely, preferably via an oven 32. The gelling and/or curing can also, however, take place by induction or infrared, etc.

This can happen at the same location, or as a result of a relative movement of the trickle device 24 and the stator 10 with respect to one another. For a unit which is optimized in terms of cost, it is advantageous if the trickle region 34, the gelling region 36 and the curing region 38 are subject to 100% utilization and are not blocked mutually.

In the case of trickle units 26 for great quantities, the aim is therefore to design the stators/gelling stations/trickle stations in such a way that trickling and gelling can take place at the same time. This means that the station is released for the next stator 10 after the trickling. This takes place, in particular, by further transporting of the stator 10, since this is less expensive in comparison with the movement of the trickle and gelling station. The transport between trickling and gelling which should take place as far as possible without an interruption can take place via a transport device 40 which can have a conveyor belt 42 and/or a handling unit 44 (for example, a robot arm 46).

In particularly preferred embodiments, clamping of the stator 10 on the internal diameter is avoided during gelling. The avoiding of clamping on the internal diameter has advantages, in particular, since resin again collects and gels on account of the capillary action, and therefore undesired resin residues again remain on the internal diameter, and at the same time the jaws are also contaminated and have to be cleaned.

Particularly in the case of the use of an oven for gelling, cleaning or exchange at these high temperatures of up to 200° C. is critical and time-intensive. Therefore, clamping of the stator 10 from the outside during gelling is highly advantageous.

In preferred embodiments, the holder 48 which is of robust design with respect to the influence of heat is provided as clamping apparatus at the gelling station/curing station. On account of the effects of temperature, tensions can arise on account of different coefficients of thermal expansion. Furthermore, preferred maintenance-free lubrication is difficult at gelling temperatures of up to 200° C. The trickle unit 26 and the holders 48 used herein are designed in such a way that occasional leaking of the resin from the stator 10 in the case of disruptions does not impair the functional capability of the respective unit components here. Unforeseen leakage is therefore critical, since the resin itself has a very high capillary action and penetrates into every gap (for example sealing rings, bearings), and subsequently cures at the process temperature and might lead to the functional failure of the component.

In preferred embodiments, as few actuating systems as possible are therefore used in this region, and guides are attached in such a way that they cannot be contaminated with resin by a leaking stator 10.

In preferred embodiments, the stators 10 can be positioned rotationally at the gelling station without an additional actuating system for clamping purposes. No actuator for rotating or clamping is positioned directly in the hot region; this saves the costs for measures for temperature resistance of actuators.

In the case of the stators 10 to be trickled, it is to be mentioned that stators 10 are increasingly used which do not have a cylindrical outer surface. That is to say, smaller non-cylindrical elements can be present (welded seams, identifying grooves), but larger non-cylindrical elements can also be present (cooling ducts, fastening tabs or the like). Some embodiments of the holder 48 are designed in such a way that stators 10 of this type do not have to be clamped in a positionally oriented manner either.

In some embodiments, the stator 10 is mounted or transported rotationally without interruption from the start of trickling to the end of gelling. In some embodiments, the stator 10 is not clamped on the inside at least during gelling in order to avoid resin residues on the internal diameter. Some embodiments relate to an inexpensive mass production unit, in which local transfer of the stator 10 additionally takes place from trickling to gelling even without an interruption in the rotation about the longitudinal axis.

Special embodiments of the holder 48 are designed in such a way that the two winding heads 28 are accessible from the inside and from the outside during trickling. In some embodiments, possible swivelling of the rotational axis about up to ±15° is also advantageous. In some embodiments, the swivel angle can also be greater than ±15°. In preferred refinements of the holder 48, clamping on the outside is provided which is to be preferred for possible swivelling even during trickling. Clamping on the outside preferably takes place substantially only in the region of the laminated core 14, however. Here, in preferred embodiments, a clamping unit/the holder 48 does not protrude or protrudes only slightly in both axial directions beyond the ends of the end surfaces 30 of the laminated core 14, as a result of which highly satisfactory access for the trickle nozzles 22a-22d to the winding heads 28 is still ensured. In some embodiments, a virtually radially oriented trickle nozzle 22a-22d onto the groove insulating papers 20 which project only slightly axially beyond the laminated core 14 is provided, in order to prevent spraying of the resin onto the end surface 30 of the laminated core 14.

In some embodiments, this is also possible with a stator 10 which also has local elevations on the external diameter (for example, fastening tabs). The method/apparatus or trickle unit is independent of the outer contour of the stator 10 in some embodiments, in order for it also to be possible for stators 10 with different outer contours to be produced via the same unit.

For a space-saving unit, the trickle unit 26 and/or its unit components are/is ideally designed in such a way that the stators 10 can be arranged tightly next to one another.

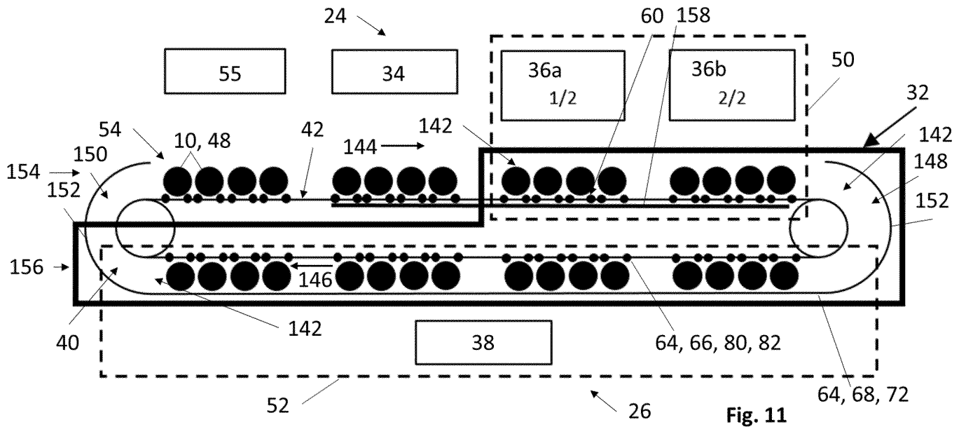

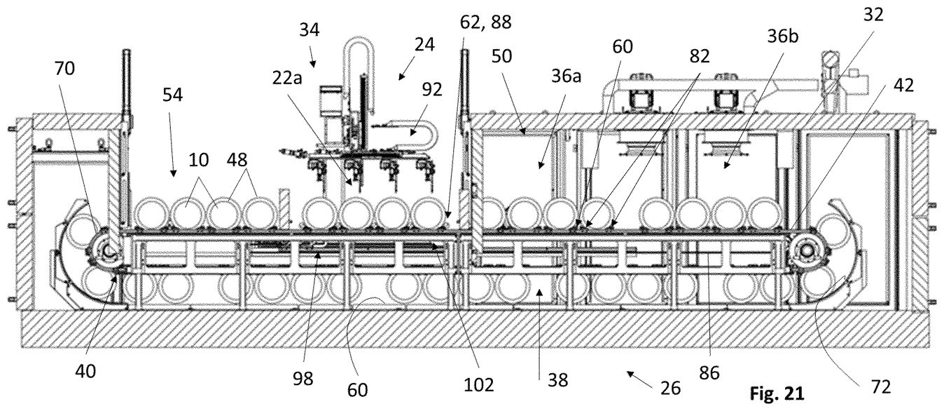

A first exemplary embodiment for a trickle unit 26 is shown diagrammatically in FIG. 9 without and in FIG. 11 with an oven 32 and in greater detail in one possible detail embodiment in FIGS. 21-23. The trickle unit 26 has, as unit components, a trickle device 24 with a trickle region 34, a gelling device 50 with a first gelling region 36a and a second gelling region 36b, a curing device 52 with a curing region 38, and a transport device 40. Furthermore, a series of holders 48 are provided which are configured to each holder stator 10. Furthermore, the trickle unit 26 has a loading and unloading place or a loading and unloading station 55 (station for loading and unloading).

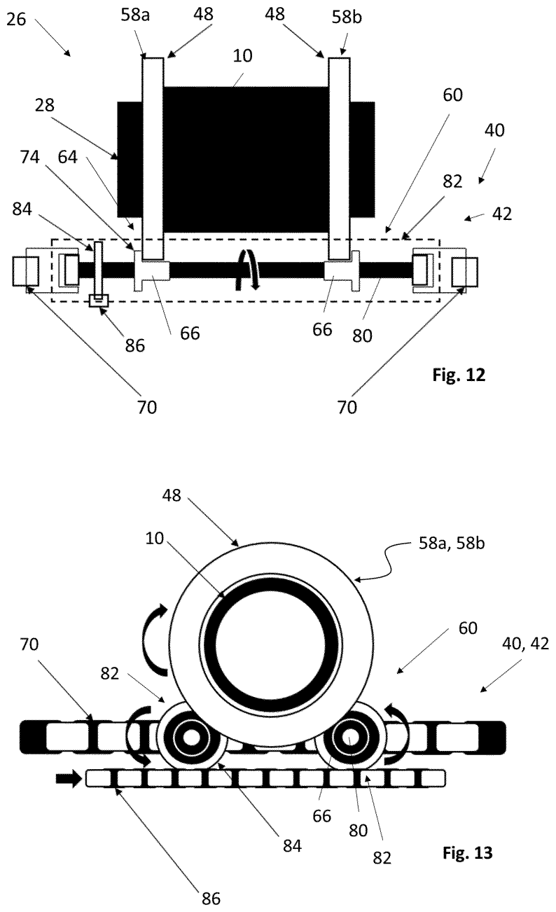

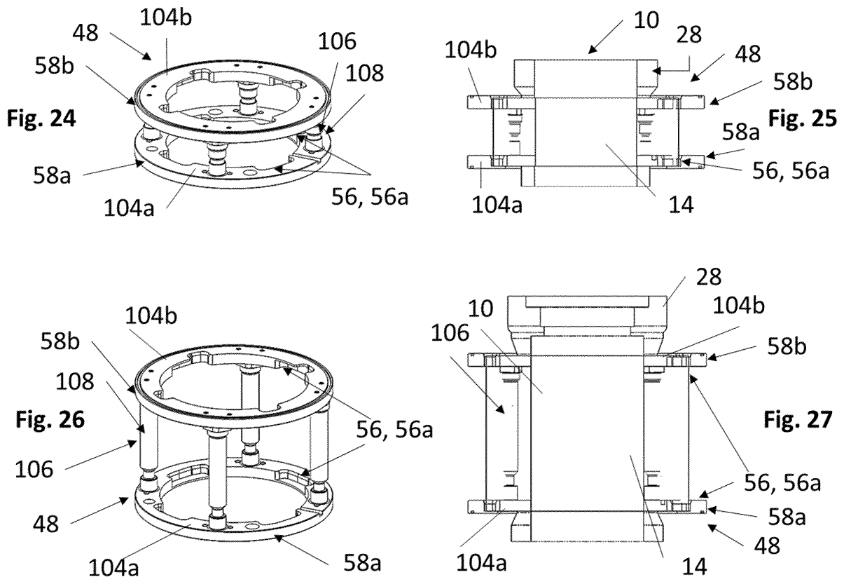

The respective holder 48 which is shown diagrammatically in FIGS. 12-16c and in FIGS. 21 to 23 and is shown in greater detail in specific possible embodiments in FIGS. 24 to 39b is configured to hold, rotate and transport in each case one stator 10 in the course of an impregnation of the stator 10 with resin. The holder 48 has a clamping device 56 for clamping in the stator 10 and at least one rolling surface 58a, 58b for rolling support of the rotating holder 48 with a clamped-in stator 10.

The holder 48 with a clamped-in stator 10 is held solely by gravity in the gelling device 50 for gelling, by virtue of the fact that the at least one rolling surface 58a, 58b is placed on a rolling device 60 (shown in FIGS. 12 and 13 and as a variant in FIG. 35) of the gelling device 50. The holder 48 with the stator 10 is rotated in the gelling region 36a, 36b about the rotational axis which coincides with the center axis of the stator by way of the at least one rolling surface 58a, 58b which lies on the rolling device 60.

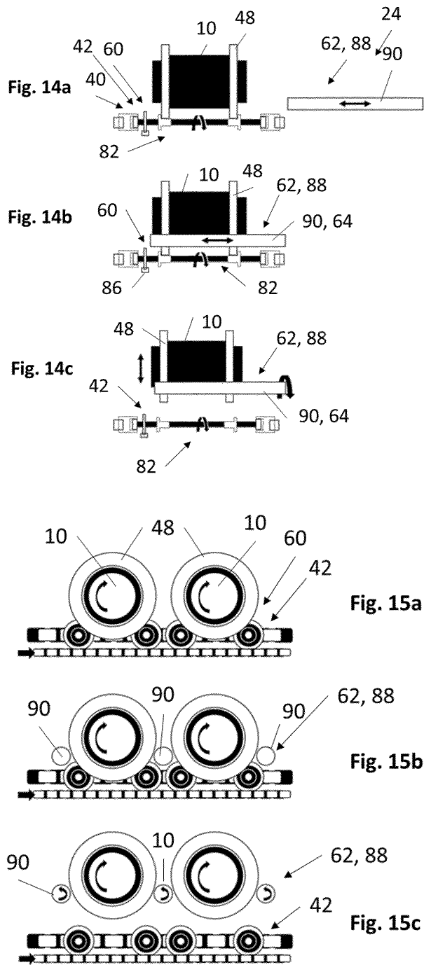

The holder 48 with a clamped-in stator 10 is also held solely by gravity in the trickle device 24 for trickle impregnation by the at least one rolling surface 58a, 58b being placed on a rolling device 62 (shown in FIGS. 14a-14c-16c) of the trickle device 24, and is rotated about the rotational axis which coincides with the center axis of the stator 10.

The respective rolling device 60, 62 has a plurality of guide elements 64, onto which the at least one rolling surface 58a, 58b is placed. The guide elements 64 are configured to guide the holder 48 in such a way that it performs a concentric rotation about its center axis/longitudinal axis. In some embodiments, the guide elements 64 for lateral guidance are configured in such a way that the holder 48 maintains its axial position (position in the axial direction, that is to say in the direction of the stator axis/center axis) even during rotation.

The guide elements 64 of the respective rolling device 60, 62 are each configured in a complementary manner in order to configure the at least one rolling surface 58a, 58b. Examples for the guide elements 64 are rollers 66, pinions, contoured wheels, toothing systems, rails 68, (circulating) chains such as transport chains 70 or traction mechanisms or the like, in particular endless traction mechanisms, running surfaces 72, rollers 66 with flanged discs 74, rollers with V-shaped grooves, rollers with a spherical running surface, rollers 66 with an annular projection 76 on the running surface, rollers with grooves on the running surface, rollers which are connected by means of a chain such as, in particular, a transport chain 70 or traction mechanisms or the like or conveyor belt 42, actively driven rollers, actively driven pinions, and rollers, pinions or contoured wheels which are connected by a common shaft 80.

In the following text, the transport device 40 of the trickle unit 26 in accordance with the first embodiment will be explained in greater detail on the basis of the illustration in FIGS. 9 to 13.

The transport device 40 is configured as a circulation system. The transport device 40 provides the rolling device 60, on which the stators 10 which are held in the respective holders 48 are supported purely by gravity at the loading and unloading station 55 by way of the at least one rolling surface 58a, 58b, and which rolling device is also provided in the gelling device 50 and the curing device 52 on account of its circulating course.

In order to form the rolling device 60, the transport device 40 has a conveyor belt 42, in particular in the form of a circulating transport chain 70, with rollers 66 which extend with their rotational axis transversely with respect to the conveying direction, and rails 68 or other running surfaces 72. The rollers 66 are provided with measures for positioning and guiding the holders 48 in the transverse direction, for example flanged discs 74 (see FIG. 12) or annular projections 76 (see FIG. 35) or the like.

A first run of the conveyor belt 42 runs in an upper region of the trickle unit 26, where, as viewed in the conveying direction, first of all the loading and unloading station 55, then the trickle device 24 and then the first gelling region 36a and then the second gelling region of the gelling device 50 are situated.

In this upper region, for transport purposes, the at least one rolling surface 58a, 58b of the holder 48 lies on two shafts 80 which are adjacent in the conveying direction by way of rollers 66, as is shown in FIGS. 9 to 13.

The conveyor belt 42 is then deflected, and a second run of the conveyor belt 42 is situated in a lower region of the trickle unit 26 above the stators 10 until the conveyor belt 42 is deflected upwards again at the other end. At the deflection regions and in the lower region, the rails 68 or the other running surface 72 are provided, on which the at least one rolling surface 58a, 58b lies, with the result that the stators 10 are guided in their holders 48 through the curing device 52 which is configured in the lower region, and are subsequently guided upwards again to the loading and unloading station 55. Here, the rollers 66 of the conveyor belt 42 act at the top on the holder 48 and thus drive the movement.

The first exemplary embodiment (shown in FIGS. 9 to 23) of the trickle unit 26 with its different unit components is configured as a circulation system which is preferably designed as a chain circulation means. Here, the circulation system is divided into the individual application steps loading/unloading, trickling and gelling which can take place at the same time.

Accordingly, in preferred variants of the first exemplary embodiment of the trickle unit 26, the transport device 40 has a circulating transport track 142 with an infeed region 144 and a return region 146 and deflection regions 148, 150 in between, and the conveyor belt 42.

The conveyor belt 42 is configured such that the stators 10 can be placed onto or lifted from the conveyor belt 42 transversely with respect to the respective stator axis and, during transport through the infeed region 144 or return region 146, lie rotationally at least in sections on the conveyor belt 42.

In some embodiments, the conveyor belt 42 is arranged in the infeed region 144 below the stator axes of the stators 10 which are situated in the infeed region 144 during operation, with the result that the stators 10 can be transported, lying on the conveyor belt 42, through the infeed region 144 of the transport track 142.

In some embodiments, the transport device 40 has, in the return region 146, the running surface 72 for placing the stators 10 to be transported through the return region 146. For example, the running surface 72 is configured on rails 68 or other guide elements 64.

In some embodiments, the conveyor belt 42 is arranged in the return region 146 above the stators 10 which are situated in the return region 146 during operation, and is configured to drive the movement of the stators 10 which roll on the running surface 72.

In the embodiments which are shown, the loading and unloading station 55 is arranged at the start of the infeed region 144 of the circulating transport track 142, and is configured in such a way that the stators 10 can be placed onto and lifted from the conveyor belt 42 transversely with respect to the stator axis.

In the embodiments which are shown, the deflection regions 148, 150 have deflection curves 152 for grasping the stators 10 and deflecting their movement parts.

In some embodiments, the regions 34, 36a, 36b, 38, 55 of the impregnation unit (trickle unit 26) are arranged on a plurality of levels 154, 156. For example, the impregnation region 34 and a gelling region 36a, 36b are provided on a first level 154, preferably an upper level, while a curing region 38 is provided on a second level 156, preferably a lower level.

It is provided, in particular, that the infeed region 144 and the return region 146 are arranged above one another. The infeed region 144 is preferably arranged above the return region 146.

In the embodiments shown of the first exemplary embodiment of the trickle unit 26, the infeed region 144 of the transport path 142 leads through the impregnation region 34 and the gelling region 36a, 36b of the impregnation unit (trickle unit 26), wherein a rotary drive mechanism 158 is provided in the impregnation region 34 and the gelling region 36a, 36b in order to drive a rotational movement of the stators 10 which lie on the conveyor belt 42. For example, the rotary drive mechanism 158 has a drive chain 86, 86a, 86b, 86c for driving a rotation of the stators 10 (also called a rotational chain in the following text).

In the embodiments which are shown, the return region 146 and/or at least one or both of the deflection regions 148, 150 lead through the curing region 38 of the impregnation unit (trickle unit 26) which lies downstream of the gelling region 36a, 36b in the transport direction.

In the embodiments which are shown, furthermore, the conveyor belt 42 has at least one circulating traction mechanism (such as, in particular, the transport chain 70) and rollers 66 or rolls 82 attached to it for the stators 10 to lie on the inner rolling manner. The rollers 66 or rolls 82 can be rotated about rotational axes which run transversely with respect to the transport direction.

As has already been described, a plurality of holders 48, configured in particular as cages, with stators 10 can be situated in the circulation system per work step, in order that a high utilization rate is achieved. For example, in each case one batch 54 of a plurality of holders 48 with stators 10 is situated in each of the unit components; in the example, in each case one batch 54 of four holders 48 is shown.

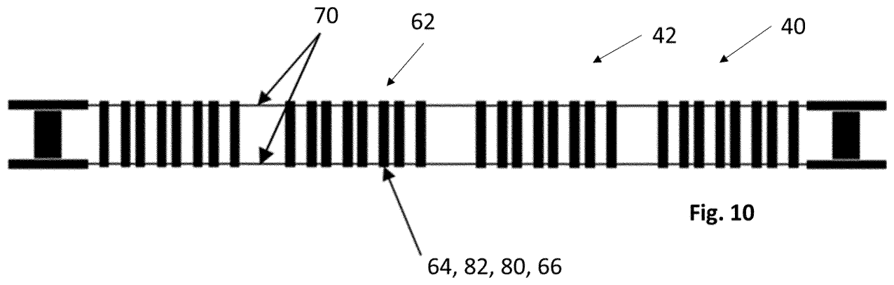

FIG. 9 diagrammatically shows a fundamental concept of the trickle unit 26. The stators/cages/holders 10, 48 are loaded radially from above and then lie on the shaft 80 of the transport chain 70 purely due to gravity. As shown in FIG. 10, the shaft 80 are preferably attached between two transport chains 70, as a result of which are relatively simple and inexpensive construction is achieved. Depending on the requirement, it is also possible for the circulation system to be equipped with more than only one gelling place (first and second gelling region 36a, 36b are indicated here), and for the trickle unit 26 to be of modular construction. FIG. 10 shows the trickle unit 26 together with the oven 32 which extends over the gelling device 50 and the curing device 52.

In order that the resin of the stators 10 does not leak, it is provided in the case of the trickle unit 26 that they rotate during the trickling and the gelling. One exemplary embodiment for a rotary drive or driving a rotation of this type will be explained in the following text on the basis of the illustration in FIGS. 9, 12 and 13.

The shafts 80 which serve as receiving rolls 82 are preferably configured with a pinion 84 or the like. As a result, each holder 48/stator 10 in this region can be set permanently in rotation here by way of only one drive and one drive chain 86 or the like. The drive chain 86 for the rotation is driven independently of the transport chain 70. The independence of the (rotational) drive chain 86 from the transport chain 70 brings it about that the rotation is maintained during the further transport from, for example, trickling to gelling, or add a standstill of the transport chain 70, as is shown in FIG. 13.

For a smaller footprint of the entire trickle unit 26, it is provided in some embodiments (not shown) that the gelling process is carried out in the upper and lower level, or only in the lower level. For this purpose, in a similar manner to the circulating transport chain 70, the drive chain 86 can be guided over the two levels 154, 156 and around the stators 10 in the slotted guide (running surface 72) of the first deflection region 148.

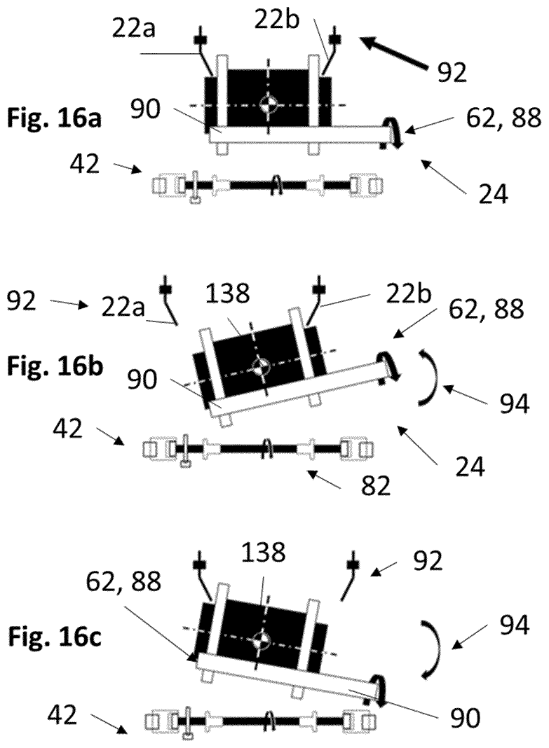

In the following text, one exemplary embodiment and the function of the rolling device 62 (configured here as a lifting device 88) of the trickle device 24 will be described on the basis of FIGS. 14a to 16c. FIGS. 14a, 15a show different views of a first stage of lifting, FIGS. 14b, 15b show different views of a second stage of lifting, FIGS. 14c, 15c show different stages of a third stage of lifting, and FIGS. 16a to 16c show different stages of swivelling of the lifting device 88.

For a trickle unit 26 which is designed for in each case n stators 10 per batch 54, the rolling device 62 which is configured as a lifting device 88 has n+1 lifting shafts 90.

The lifting shafts 90 are mounted on a carrier (not shown) such that they can be driven rotationally at a predefined spacing from one another in the conveying direction, which carrier can be moved in the trickle device 24 horizontally and vertically transversely with respect to the conveying direction and can be swivelled in different swivelling directions. The predefined spacing is dimensioned in such a way that, on a lifting shaft 90 which is provided between adjacent receiving stations for the stators 10/holders 48, the two adjacent stators 10/holders 48 can roll on the same lifting shaft 90 arranged in between.

Furthermore, the trickle device 24 has a trickle nozzle arrangement 92 which, for example, can be moved on a gantry system horizontally transversely with respect to the conveying direction.

As has already been mentioned, it is advantageous for an improved trickle result if the trickle nozzles 22a-22d apply the resin to the winding head 28 from both sides of the stator 10, in the internal and/or external diameter and/or with a slight inclination with respect to the horizontal longitudinal axis.

As a result of the compact construction of the circulation system, it is possible for the trickle nozzles 22a-22d to be advanced, for example, from one or both sides, and even above the holders 48 as a gantry design. In addition, the holder 48 which is configured, in particular, as a cage makes it possible, as a result of the satisfactory accessibility of the stator 10, that, for example, only in each case one trickle nozzle 22a-22d is used for the internal and external diameter per stator side, or else separate trickle nozzles 22a-22d are used per stator side for the internal and external diameter.

In order to lift and therefore to swivel the stator 10, a plurality of variants are likewise conceivable. In the embodiment which is shown, the holders 48 which are configured, in particular, as cages can be lifted upward by means of the lifting shafts 90 which are advanced in the axial direction between the receiving rolls 82. The holders 48 are also held in position on these lifting shafts 90 by gravity and any profiles/V-shaped grooves/flanged discs (not shown here; see, for example, FIG. 35 for one possible configuration of the lifting shafts 90).

As a result of a separate drive of the lifting shafts 90, it is possible for the holder 48 to be received in a stationary rotating manner and also to be deposited again in a stationary rotating manner (see FIGS. 14a-14c and 15a-15c). It can also be seen in FIGS. 15a-15c that the lifting device 88 uses only one lifting shaft 90 between the holders 48 and not two, in comparison with the transport chain 70. One advantage here is that only, for example, the first lifting shaft 90 has to be driven on the lifting device 88, in order to set all further lifting shafts 90 and holders 48 in rotation, without connecting the lifting shaft 90 to, for example, a chain. This principle is likewise conceivable for the transport chain 70 if the receiving rolls 82 or rollers 66 have correspondingly large diameters, with the result that the holders 48 are not connected to one another on the external diameter.

As shown in FIGS. 16a-16c, where the swivelling of the stator 10/holder 48 with possible advancing of the trickle nozzles 22a, 22b is shown, the lifting device 88 is provided in some embodiments with a swivelling device 94 which preferably inclines the respective stator 10 about its center of gravity.

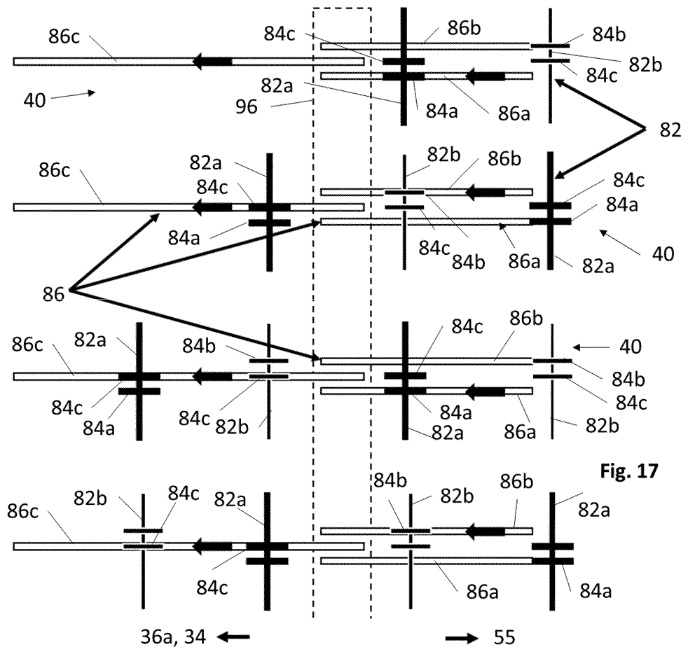

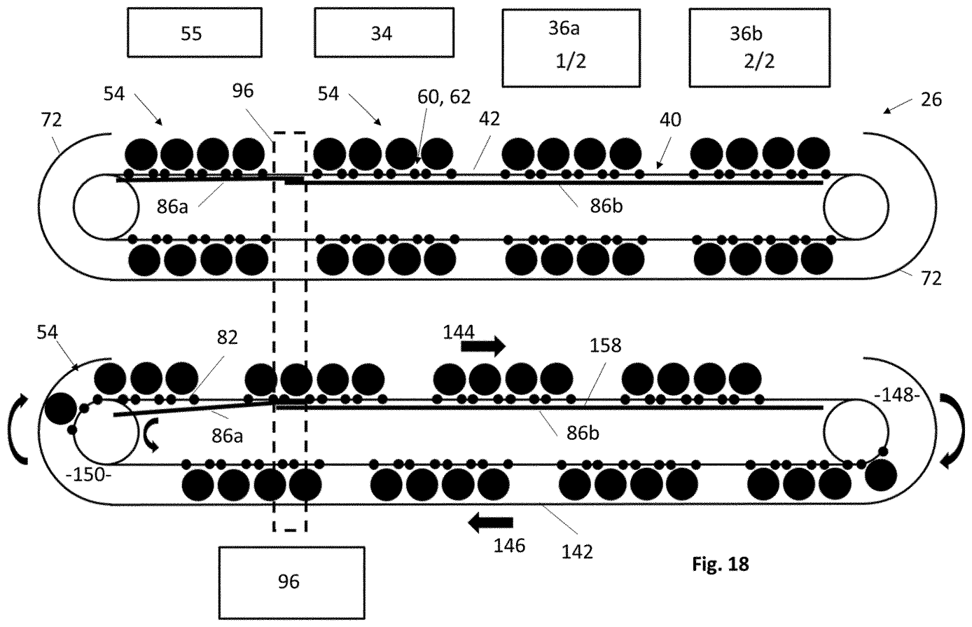

For cases, in which the stators 10 do not have to be swivelled for trickling, the trickle unit 26 is even configured without a lifting device 88 in some embodiments. Particularly preferred embodiments of this variant of the first exemplary embodiment of the trickle unit 26 are shown in FIGS. 17 and 18. These embodiments address the problem that the stators 10 which are not yet rotating at the loading and unloading station 55 have to be accelerated one after another during further cycling to the trickling. The same applies if the drive chain 86 for the rotation is routed through from the loading and unloading station 55 as far as the gelling, since the non-rotating stators 10 are transported from the lower level via the second deflection region 150 upwards to the loading and unloading station 55.

In some embodiments, of which one example is shown in FIG. 17, it is therefore provided that the (rotational) drive chain 86, 86a, 86b, 86c is, for example, of multiple-track configuration between the loading and unloading station 55 and the trickle region, and the receiving rolls 82, 82a, 82b have a plurality of pinions 84, 84a, 84b, 84c which pass alternately into engagement per batch 54. Here, one dedicated drive is provided per track.

In particular, a first to third drive chain 86a-86c are provided. A first and a second drive chain 86a are provided in parallel at the loading and unloading station 55 and are each equipped with a dedicated drive. In a transfer region 96, the third drive chain 86c which is likewise driven by way of a dedicated drive also runs parallel to the first and second drive chain 86a, 86b and then runs on its own further to the trickling/gelling region.

The receiving rolls 82 of the conveyor belt 42 have first receiving rolls 82a and second receiving rolls 82b. Either the first receiving rolls 82a or the second receiving rolls 82b are provided in each case for each batch 54; in other words, a group of first receiving rolls 82a configured to receive a batch 54 is followed by a group of second receiving rolls 82b configured to receive a following batch 54, and then in turn a group of first receiving rolls 82a, etc.

The first receiving rolls 82a have a first pinion 84a which is positioned for engagement with the first drive chain 86a in the direction transversely with respect to the conveying direction, and a third pinion 84c which is positioned for engagement with the third drive chain 86c.

The second receiving rolls 82b have a second opinion 84b which is positioned for engagement with the second drive chain 86b, and the third pinion 84c which is positioned for engagement with the third drive chain 86c.

FIG. 17 shows, one under another, for following situations during conveying of the four batches 54 which are shown in the upper level in FIG. 9, wherein only one of each group, provided for the respective edge, of receiving rollers 82a, 82b is shown. In accordance with the illustration shown at the very top in FIG. 17, a first batch of holders 48 with stators (not shown in FIG. 17; the first batch has, for example, four stators 10 in corresponding holders 48) is first of all placed on first receiving rolls 82a. The latter are in engagement via the first pinion 84a with the first drive chain 86a. This first drive chain 86a is driven, in order to begin the rotation of the stators 10 of the first batch and to accelerate it. This batch is then cycled further, and the rotating stators 10 of the first batch are transferred to the third drive chain 86b which further drives the rotation via the third pinion 84c. second receiving rolls 82b for receiving a following second batch have already been advanced while first receiving rolls 82a of the first batch are situated at the loading and unloading station 55, but they are not in engagement with the first drive chain 86a, but rather only with the second drive chain 86b which is not yet driven here. Subsequently, the second batch is placed onto the advanced group of second receiving rolls 82b. In accordance with the illustration in the second row of FIG. 17, the second drive chain 86b is then driven in order to set the second drive rolls 82b and therefore the stators 10 of the second batch in rotation and to cycle them further, while first receiving rolls for a third batch are already advanced again without a rotary drive. The third row of FIG. 17 shows the acceleration of the third batch on first receiving rolls 82a, and the fourth row of FIG. 17 shows the acceleration of the fourth batch on second receiving rolls 82b.

If an even number of batches 54 (as shown in FIG. 9) are situated in the unit, it is possible to bypass the problem of different acceleration by way of alternating pinions 84a, 84b and a total of three drives (first to third drive chain 86a, 86b, 86c). In the case of an odd number of batches, the number of pinions and drives is accordingly increased.

After the stators 10 have been deposited on the loading and unloading station 55, it is provided in some embodiments, of which one example is shown in FIG. 18, that two drive chains 86a, 86c, one 86a for the loading and unloading station 55 and one 86c for the trickling/gelling region, are used with in each case one drive and the receiving roll 82 is used with a total of two pinions 84a, 84c. The system can be constructed mechanically (for example, by chain sprocket position, chain slope, feather key connections, etc.) that the chain members are aligned exactly with one another in a transfer region 96. In combination with rotary encoders which sample the position of the drive and therefore of the chain sprocket, the drive chains 86a, 86c can then be brought to an identical rotational speed and synchronized, with the result that only one change of the pinions 84a, 84c takes place during further cycling.

For the case where finished stators 10 are already conveyed out of the lower-level 156 upwards to the loading and unloading station 55, the drive chain 86a is of swivelable configuration in some embodiments, of which one exemplary embodiment is likewise shown in FIG. 18. If the holders 48 are at the same rotational speed at the loading and unloading station 55 as at the trickling and gelling station and the trickling operation is concluded, the holders 48 are transported further. Here, the first drive chain 86a is swivelled downward at the loading station 55, depending on the progress of the holders 48, with the result that the pinions of the following receiving rolls 82 do not come into contact, but still rotate the holders 48 which have not yet been completely transported further.

In the following text, the variant of the first exemplary embodiment of the trickle unit 26 with the lifting device 88 according to FIGS. 14a-16c will once again be discussed. If the stators 10 are lifted during trickling, it is a great advantage that the components 80, 82, 84, 86 of the rotational drive can be of inexpensive design, since the partially heavy stators 10 do not have to be set in rotation from a standstill, but rather are already rotating when they are placed by the lifting device 88 (see FIGS. 14a-15c) or swivel device 94 (see FIGS. 16a-16c) onto the rotating receiving rolls 82 of the conveyor belt 42. As a result, the components firstly become smaller, and the way in the system becomes lower. Moreover, the unit which serves to drive the rotation of the holders 48 can preferably be constructive as a chain system (for example, drive chain 86) with only one drive. If the trickle unit 26 is completely empty, and the first batch 54 of stators 10 is loaded, the drive chain 86 is still at a standstill and the batch 54 can be transported further for trickling. The stators 10 are then set in rotation by the lifting device 88 in a manner which is released from the transport device 40. Before the stators 10 are then deposited again in a rotating manner, the drive chain 86 starts.

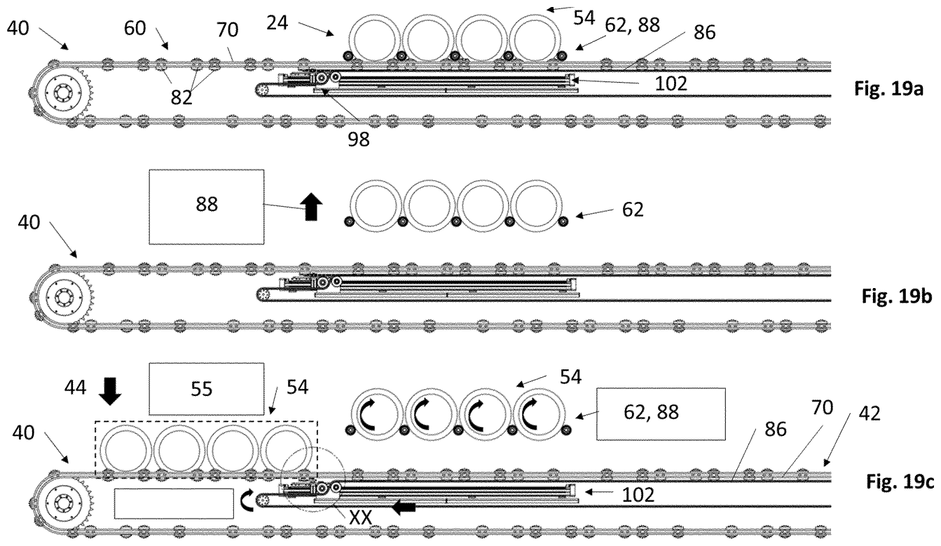

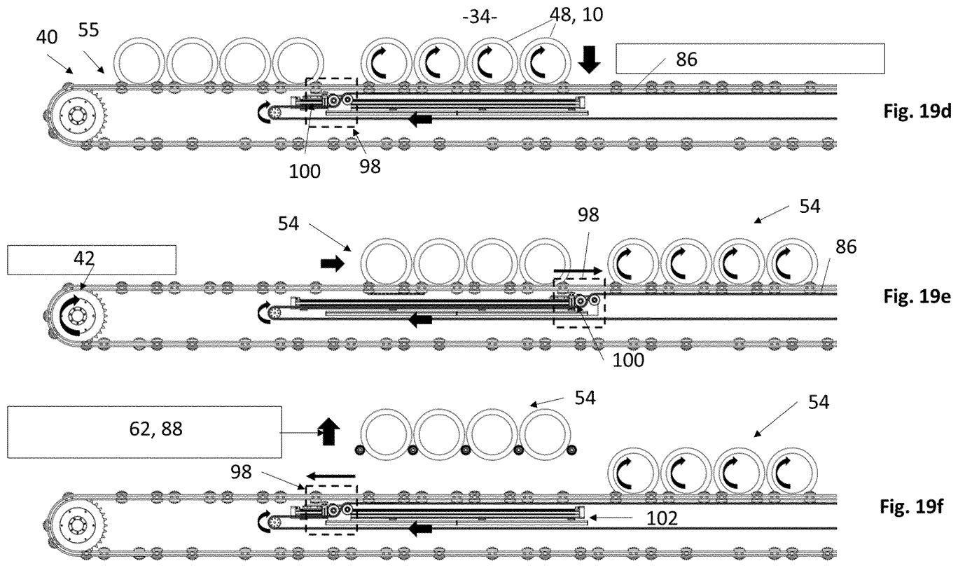

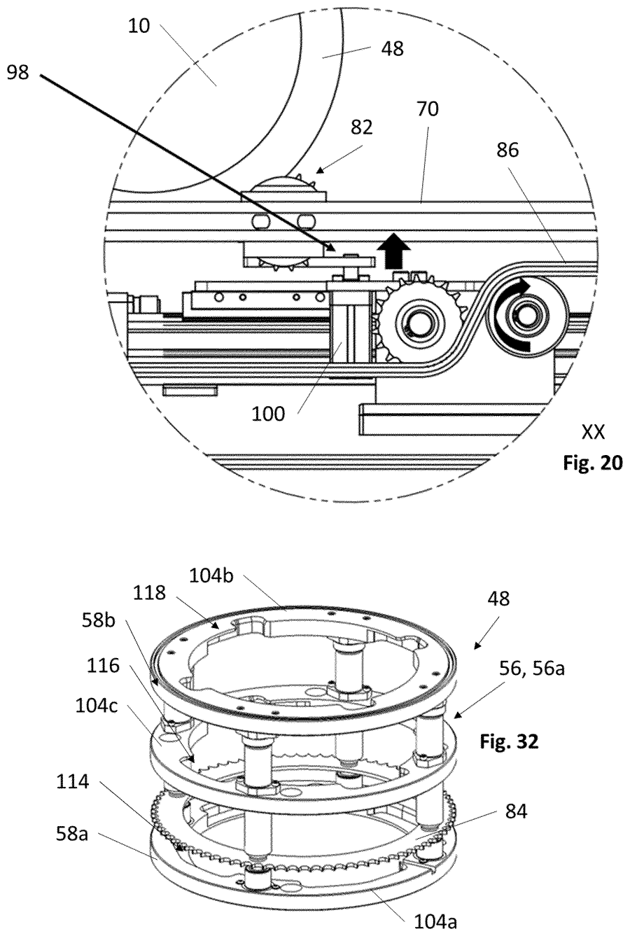

In some embodiments, of which examples are shown in FIGS. 19a-19f and 20, the unit for driving the rotation is constructed in such a way that the drive chain 86 is preferably deflected in a driver 98. The driver 98 can be displaced along the conveying direction between the positions shown in the FIGS. 19d and 19e upstream and downstream of the position for lifting on the trickle device 24. In some embodiments, a dedicated drive can be provided for displacement purposes; in the refinement which is shown, the driver (as shown in FIG. 20) can be connected to the transport chain 70.

FIG. 19a shows the situation after the batch 54 has been guided further from the loading and unloading station 55 to the trickle device 24. FIG. 19b shows the lifting of the batch 54 in the trickle device 24. FIG. 19c shows how the stators 10 of the lifted batch 54 are set in rotation. A second batch 54 is deposited at the loading and unloading station 55. At the same time, the rotation of the drive chain 86 starts. FIG. 20 shows the detail XX from FIG. 19c, where the connection between the driver 98 and the transport chain 70 is established.

FIG. 19d shows the depositing of the first batch 54 on the transport chain 70 after the trickling. The stators 10 are still held rotationally here in the holders 48.

As a result of the connection of the driver 98 to the transport chain 70, preferably by a, for example, pneumatic actuator 100 on the driver 98, the batch 54 can then be driven with the transport chain 70 from the trickling to the gelling, as is shown in the transition from FIG. 19d to FIG. 19e. When the following batch 54 is lifted at the trickle location (this takes place just before the situation shown in FIG. 19f), the connection between the driver 98 and the transport chain 70 is released. The driver 98 is moved back into the starting position by a further actuator 102, for example a pneumatic actuator. The drive chain 86 is permanently in motion here.

FIGS. 21 to 23 show a plan view, a sectional view and a perspective view (shown without a lateral oven wall) of one specific exemplary embodiment of the trickle unit 26 in accordance with the first embodiment with a (chain) circulation system.

Since the stators 10 are passed through an oven unit (oven 32) in order to cure the liquid/resin, it is also to be mentioned that, due to the higher temperature, a corresponding length expansion of the components occurs. In addition, after a relatively long operation, the transport system will display a certain amount of wear, and an elongation of the chain links will therefore occur, using the example of the transport chain 70. As a result, it happens that the positions of the holders 48, for example loading position and trickle position, are shifted. The maximum longitudinal expansion and the elongation of the transport chain 70 can be calculated, however, and this shift can therefore be counteracted.

The position of the batches 54 with respect to one another is preferably sampled by means of sensors (not shown), and the holders 48 are then conveyed by way of the transport system by a greater distance or a less great distance, or even in the opposite direction, and the offset is correspondingly compensated for. In addition, the holders 48 are deposited with the at least one rolling surface 58a, 58b on rolls/rollers 82, 66, 90 and center themselves in the process, as a result of which extra indexing is invalidated. In summary, as a result of the cylindrical shape of the holder 48 and as a result of the cylindrical shape of the lifting elements/depositing rolls 90, 82, 66, the holder 48 always rolls to the correct position, and incorrect positions can always be compensated for during fetching by way of a gripping system or during lifting for an application.

In the following text, exemplary embodiments of the holder 48 will be explained in greater detail on the basis of the illustrations in FIGS. 24 to 35. Although holders 48 with only one correspondingly longer cylindrical rolling surface are provided in the embodiments which are not shown, the holders 48 which are shown have a plurality of rolling surfaces 58a, 58b which are arranged at an axial spacing from one another. In the embodiments which are shown, the rolling surfaces 58a, 58b surround the stator 10 radially further to the outside than the outer periphery of the stator 10, with the result that the stator 10 is surrounded by the holder 48 as if by a cage.

The at least one rolling surface 58a, 58b is provided on an annular region of the holder 48. In the case of a plurality of rolling surfaces 58a, 58b, the annular regions are formed correspondingly by ring elements 104a, 104b of the holder 48 which are connected axially to one another by struts 106 which extend in the axial direction. The struts 106 can be of telescopic configuration, in particular with springs 108 (FIGS. 24-32) or can be of solid configuration.

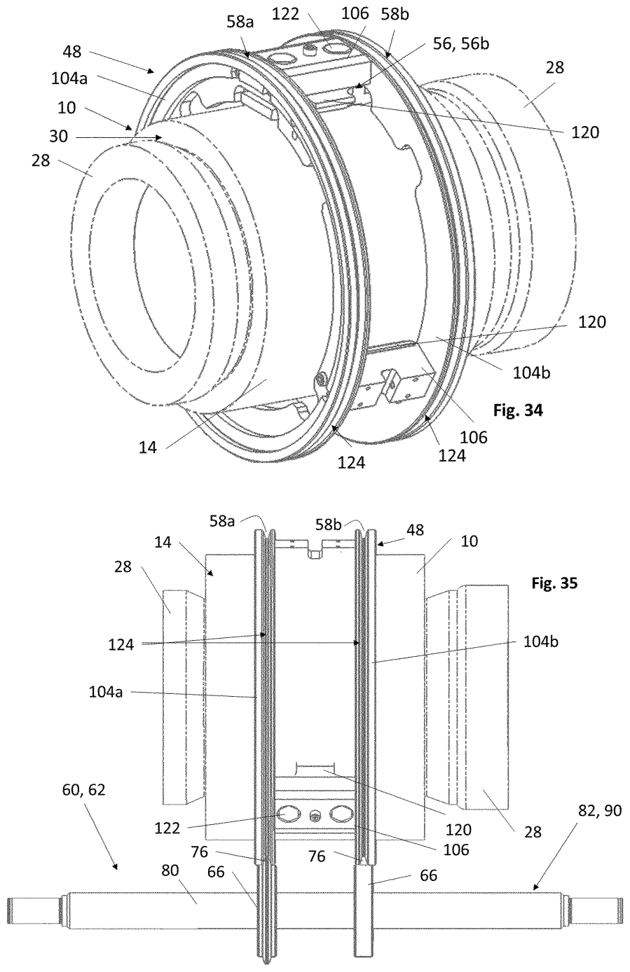

The stator 10 can be clamped in the holder 48, configured in particular as a cage, both axially and radially, depending on the embodiment. Embodiments with an axially clamping device 56a are shown in FIGS. 24 to 32. One example of a currently preferred embodiment with a clamping device 56b which clamps radially on the outer periphery of the stator 10 is shown in FIGS. 34 and 35.

In preferred embodiments, the holder 48 is designed in such a way that the stator 10 can be inserted without the elements which later clamped the stator 10 having to be dismantled.

In some embodiments, of which examples are shown in FIGS. 24 to 27, during axial clamping of a stator 10 which does not have a cylindrical outer surface, that is to say non-cylindrical elements which are usually used for screwing the finished stator 10 into a housing, the stator 10 is inserted, for example, from above into the holder 48, and either the holder 48 or the stator 10 itself is rotated about its longitudinal axis, in order to obtain an engagement as in the case of a bayonet lock. As a result, the workpiece is held in the holder 48 captively and with only a very low surface pressure. As can be seen by a comparison of firstly FIGS. 24, 25 and secondly FIGS. 26, 27, holders 48 of different length are inserted with a corresponding stroke, preferably by differently inserted springs 108, depending on the length of the laminated core 14.

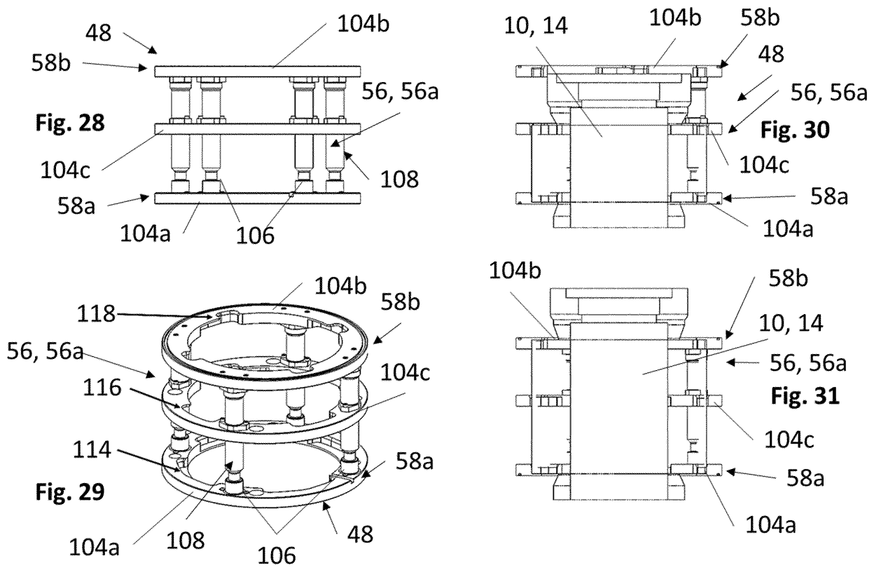

FIGS. 28 to 31 show a further possibility of axially receiving stators 10 of different length, which further possibility manages with only one configuration of the holder 48. It is provided here that the bayonet lock for each stator 10 is configured in the respective opposite direction, and therefore one stator 10 is received in the holder 48 turned to the left (FIG. 30) and the other stator is received turned to the right (FIG. 31). In accordance with FIG. 29, a common support 114 is provided to this end on a first ring element 104a, a bayonet lock which can be closed by the rotation to the right for a stator with a short laminated core length (FIG. 30) is provided on a second ring element 104b, and a bayonet lock which can be closed by rotation to the left for a stator with a long laminated core length (FIG. 31) is provided on a third ring element 104c.

A further solution for receiving stators 10 with different lengths is the embodiment of the holder 48 as a telescope.

Axial clamping of a stator with a cylindrical outer surface is possible, for example, by way of swivelling clamps (not shown) which are attached between the ring is 104a, 104b of the holder 48 and in the case of which the engaging means swivel in, after the insertion of the stator, and subsequently clamp onto the end of surfaces 30 of the laminated core 14. The engaging means can be advanced here both by hand and automatically with the aid of an actuator.

In some embodiments, of which one example is shown in FIG. 32, it is likewise possible on account of the cylindrical outer shape of the holder 48 for the necessary rotation for the trickling and gelling to be realized directly via the holder 48 itself and not via the receiving shafts or rolls 80, 82, 82a, 82b of the transport chain 70. The above-described pinion or pinions 84, 84a, 84b, 84c on the receiving rolls 82, 82a, 82b is/are mounted directly here on the holder 48, and the receiving shafts 80, 82 serve merely as a rotating rack. Although shown here only on one of the exemplary embodiments of the holder 48, these pinions can be provided on the different configurations of the holders 48 (radially or axially clamping; with or without bayonet lock, etc.).

Accordingly, a plurality of variants are also conceivable when receiving stators 10 which are to be clamped radially, of which variants one example is shown in FIGS. 34 and 35. In a similar manner to the swivelling clamps, clamping elements 120 with pressure pieces/frictional surfaces which bear radially against the laminated core are attached between the rings 104a, 104b of the holder 48. The pressure pieces can be advanced, for example, via a toggle lever, an eccentric clamp, or via a worm/wedge mechanism 122, or else can be configured as swivelling clamps.

Radial clamping has, in particular, the advantages that the holder 48 which is configured, in particular, as a cage does not have an axial overhang beyond the laminated core 14, with the result that there is improved access for the trickle nozzles 22a-22d. Furthermore, the same holder 48 is suitable for clamping in stators 10 of different length. Furthermore, radial clamping in functions both in the case of stators with a cylindrical outer surface and in the case of stators with radial projections. FIG. 35 shows the holder 48 in contact on one of the rolling devices 60, 62. The rolling surfaces 58a, 58b on the rings 104a, 104b have a V-shaped groove 124, into which annular projections 76 of complementary configuration on rollers 66 which are configured or seated on the shaft 80, 90 engage. This guidance has proved advantageous with regard to the lowest susceptibility to contamination.

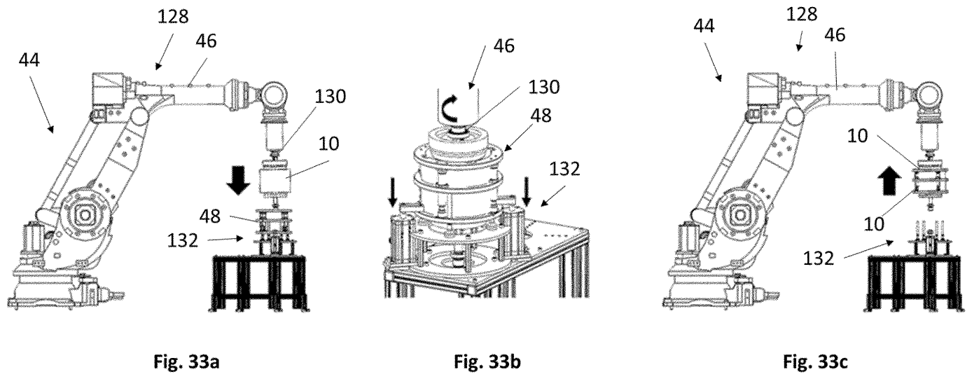

FIGS. 33a to 33c show different stages of one example for an automated insertion of a stator 10 into a holder 48. In some embodiments, of which one example is shown in these figures, it is possible for the stator 10/holder 48 to be transported by way of a gripper 126. Here, the gripper 126 is fastened, for example, to a linear gantry or to a robot 128. For example, the stator 10 is received on the internal diameter by way of a clamping mandrel 130 (with an internal clamping unit 12 as shown in FIG. 1), while the holder 48 is situated on a rack 132.

In some embodiments, the gripper 126 is designed in such a way that it can rotate the stator 10 relative to the holder 48 for introduction into the holder 48 or else for removal, in order thus to connect the stator 10 and the holder 48 to one another by way of a bayonet 116, 118. In other embodiments (not shown), the rack 132 is configured to receive the stator 10, and an outer gripper is provided on the robot 128 and is configured to receive the holder 48 on the outer contour, to push it over the stator 10, and to subsequently rotate the holder 48 relative to the stator 10 when receiving the stator 10. In further embodiments (not shown) which interact, in particular, with the holder 48 according to FIGS. 34 and 35, an actuator for actuating the clamping device 56b after insertion of the stator 10 is provided on the rack 132 for the holder 48.

As can be gathered, in particular, from FIG. 33c, the stator 10 and the holder 48 are transported, after the clamping of the stator 10 in the holder 48, via the same gripper 126, for example with an interior clamping mandrel, to the loading station 55 of the trickle unit 26 and are deposited onto it. After the stator 10 has been trickled and the resin is cured, the gripper 126 can fetch the finish stator 10 again and separate the holder 48 from the stator 10 again at the rack station 132.

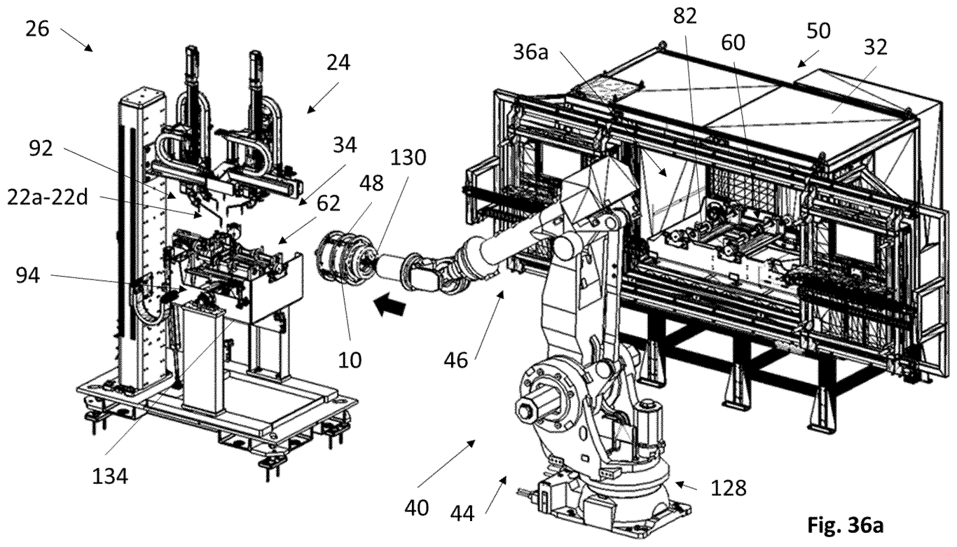

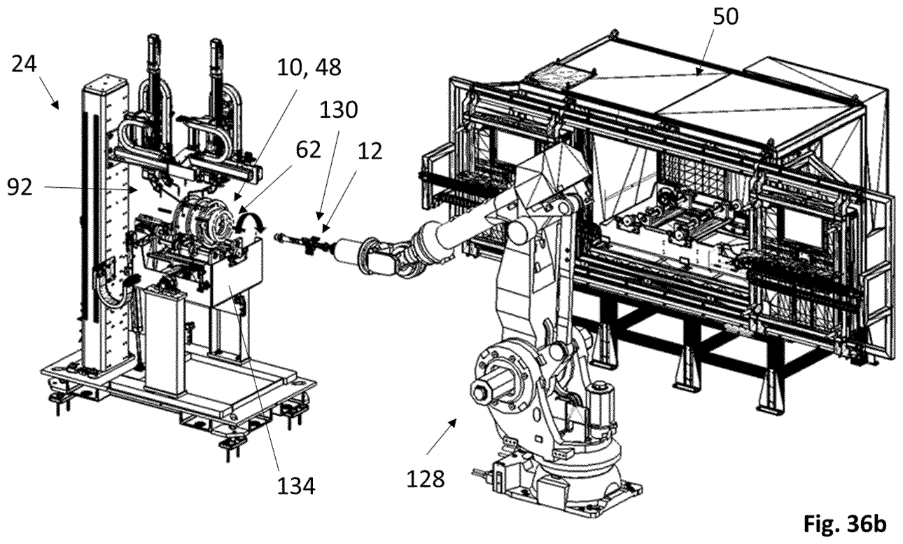

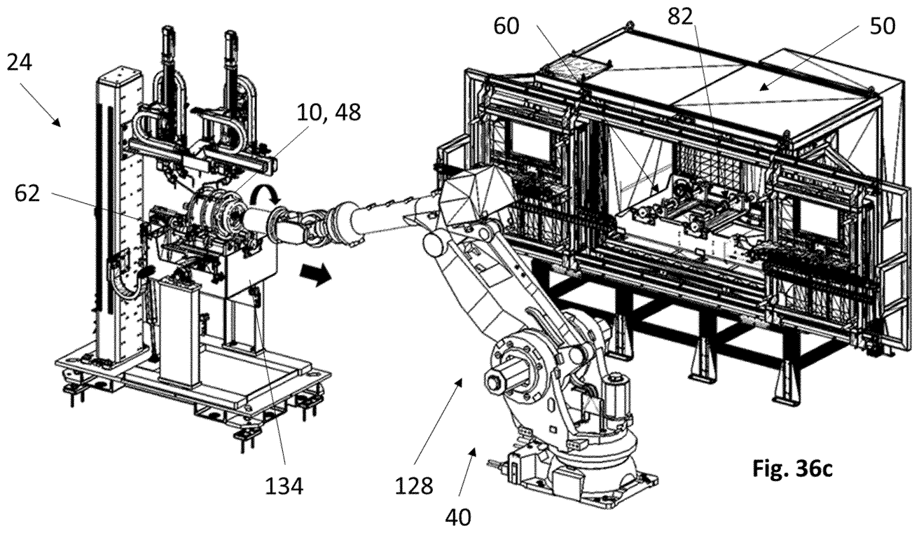

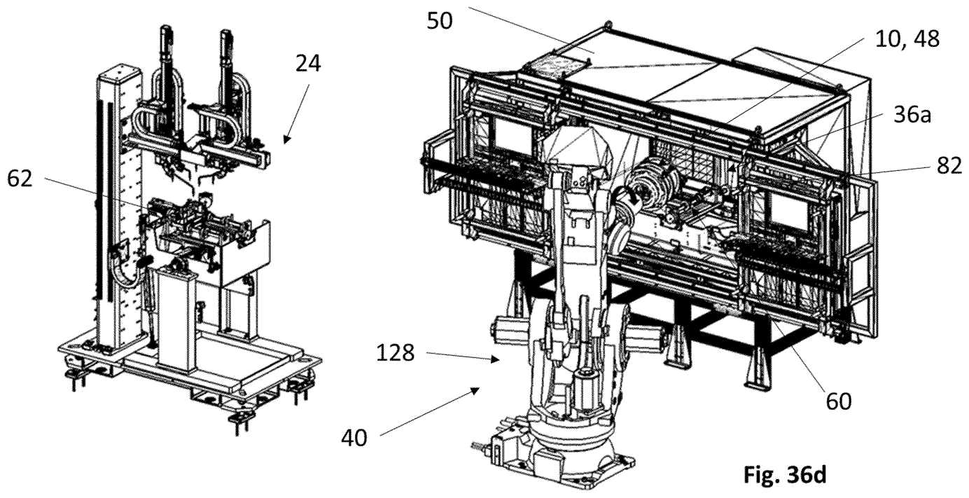

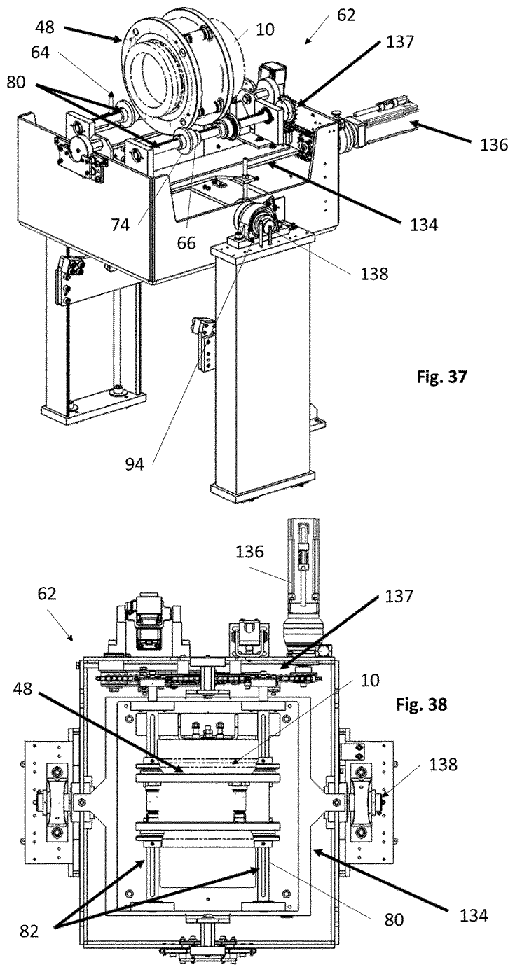

In the following text, further exemplary embodiments of the trickle unit 26 will be explained in greater detail on the basis of the illustrations in FIGS. 36a to 39b. These exemplary embodiments do not have a circulation system as transport device, but rather the transport device 40 have substantially the robot 128 with a gripper 126. The rolling device 62 of the trickle device 24 is configured as shown in FIGS. 37 to 39b. The configuration of the rolling device 60 of the gelling device 50 is shown in FIGS. 36a to 36d which show different stages of the trickle method. The rolling devices 62, 60 each have rotatably driven shafts 80, on which the holder 48 can be mounted so as to lie with its at least one rolling surface 58a, 58b by way of gravity. For example, the respective shaft 80 can be configured as shown in FIG. 35.

It is provided in the further exemplary embodiment shown that the stator 10 with the holder 48 is not deposited at a loading station 55, but rather is transported directly for trickling. The gripper 126 is equipped with an additional rotational unit 134 which allows it to receive the holder 48 rotationally after the trickling and deposit it again rotationally at the gelling station. FIG. 36a shows how the robot 128 loads the holder 48 for trickling. FIG. 36b shows how the holder 48 and the stator 10 rotate during the trickle process. FIG. 36c shows how the robot 128 lifts the holder 48 and the stator 10 rotationally from the trickling. In addition, in the illustration of FIG. 36d, the robot 128 deposits the holder 48 with the stator 10 rotationally on the rolling device 60 of the gelling device 50, where it is further driven rotationally for gelling. Although the robot 128 is shown here with the interior clamping mandrel (interior clamping unit 12), it should be clear that the gripper 126 can also be configured for direct gripping of the holder 48. For example, the holder 48 can have gripping regions (not shown), on which the gripper 126 can act.

Accordingly, it is provided in some embodiments (as described above with respect to FIGS. 9 to 23) for the receiving rolls 82, 82a, 82b to be fastened to a transport system, for example a transport chain 70, which receiving rolls are cycled further between the applications, such as trickling, gelling and curing. In other embodiments, of which examples are shown in FIGS. 36a to 39b, the receiving rolls 82, onto which the holder 48 is deposited, are of stationary construction in contrast, wherein the handling between trickling and gelling is implemented, for example, by means of a robot 128 or the like. The force to be applied for rotation can also be introduced at the stationary rolling devices 60, 62 which are in the trickle region 34 and in the gelling region 36a/oven 32 directly into the holder 48 or else via the receiving rollers 82 as mentioned in a non-positive manner (for example, friction wheels, or friction wheel with belt, etc.) or in a positively locking manner (for example, chain with pinion, toothing system via spur gears, etc.). As can be seen from FIGS. 37 and 38, the receiving rollers 82 are mounted rotatably on a frame 134 in the stationary rolling devices 62 (analogously in the case of the rolling device 60), and the necessary torque is introduced by an external drive 136.

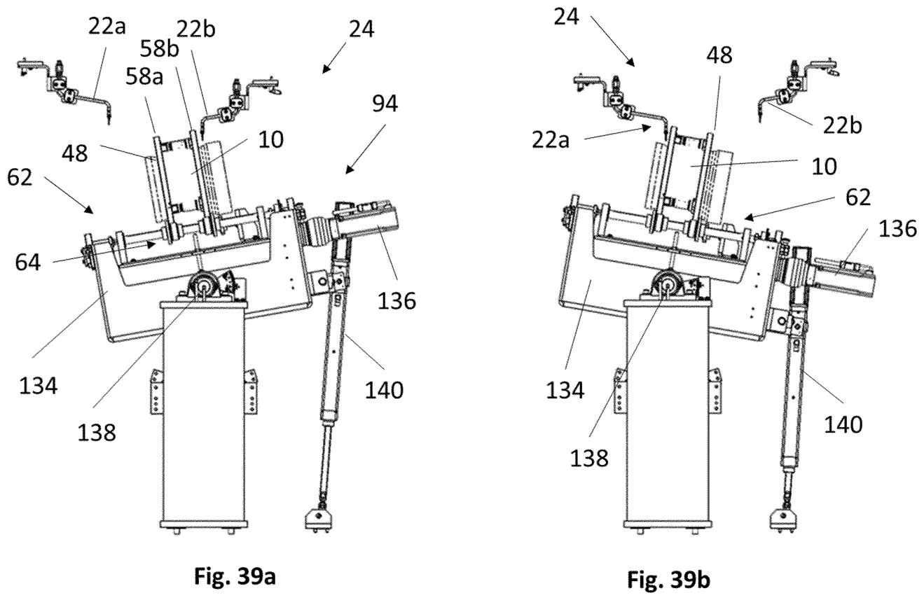

The rolling device 62 for the trickle device 24 can also be provided with the swivel device 94 in the stationary version. To this end, the frame 134 is mounted such that it can be swivelled about a swivel axis 138. Swivelling into different swivel positions is actuated via a swivel actuator 140, as shown in FIGS. 39a and 39b.

As has already been mentioned, it is advantageous for an improved trickle result if the workpiece to be trickled is swivelled into its horizontal position. It is even possible in the case of this stationary depositing for the rolling device 62 to be pivoted in the required range, in order then to position the trickle nozzles 22a, 22b, for example, from above at the correct location.

In the different embodiments shown of the trickle unit 26, the stator 10 is held in each case in position only by gravity alone during the trickle operation during the gelling operation during the transport from the trickle to the gelling operation or any desired combination thereof, and is rotated about its own horizontally lying axis.

To this end, if present, a cylindrical outer surface on the stator 10 can be used directly; the rolling devices 60, 62 are also suitable, in particular, for rolling on a cylindrical outer surface, provided directly on the stator 10, as rolling surface. The stator 10 is preferably premounted in the holder 48 before trickling, by way of which holder the stator 10 is deposited into the trickle region, gelling region or transport region, or a combination thereof. One advantage of a holder 48 of this type, in particular configured as a cage, is that stators 10 with a non-cylindrical outer contour or protruding elements such as screw-on possibilities, interconnecting elements, etc. can also be deposited in a rotational manner into an associated rolling device 60, 62. Here, gravity is also sufficient for the transmission of force for rotation of the stator 10 with or without a holder 48. Therefore, the rolling device 60, 62 can receive, position and rotate a stator 10 or holder 48, without the holder 48 or stator 10 itself being clamped or held actively by the rolling device 60, 62. No actuator on the holder 48 itself or on the rolling device 60, 62 is therefore necessary. The holder 48 is held in position by gravity after loading into the rolling device 60, 62, and the gravity of the holder 48 with a stator 10 is sufficient for it to be possible for the rotational transmission into the holder 48 to take place. This transmission of force is preferably introduced in this case into the holder 48 or stator 10 via rotating rollers 66 on the rolling device 60, 62, which transmission of force takes place on an outer surface (as rolling surface) of the holder 48 with the stator or on the stator 10 itself.

Here, the transmission of force can be in a purely frictionally locking manner (for example, by way of friction wheels as rollers) or in a positively locking manner such as, for example, a toothing system (for example, pinion 84).

Here, the positioning of the holder 48 or stator 10 can take place via four rollers 66 as in the present case, and the introduction of the force for rotation takes place via the same rollers 66, or via separate rollers 66 or, for example, via a separate pinion 84. As mentioned, no clamping apparatus, holding apparatus or actuator is required in the receptacle, configured as a rolling device 60, 62, for the holder 48/stator 10, in order to hold the holder 48 or the stator 10 in position on the rolling device 60, 62; no actuator, force, etc. has to be introduced into the rolling device 60, 62 during loading or unloading of this rolling device 60, 62 either, since the stator 10 or holder 48 remains in this position purely by way of gravity. The necessary torque is also preferably forwarded via these guide elements 64 or positioning elements (for example, rollers 66) to the stator 10 or holder 48 for the rotational movement, wherein all the positioning element/guide elements 64 preferably also forward the rotational movement here (as in the case of an all-wheel drive). One possible function of the rolling device 60, 62 is therefore to hold the holder 48 or stator 10 in position, and to correspondingly forward a force for rotating the stator 10, without having an active actuator here for generating the force for the rotational movement. The necessary force for rotating the stator 10 or holder 48 is therefore not generated actively in the rolling device 60, 62, but rather is generated externally and is merely forwarded through the rolling device 60, 62. This force can also be generated by any other energy form (pneumatics, fluid). That is to say, the rolling device 60, 62 itself does not have an energy converter which converts, for example, electric or pneumatic energy into a force or into a torque, but rather a mechanical power output is merely conducted through the rolling device 60, 62. This has the advantage that no temperature-resistant and, as a result, expensive actuators have to be used if the rolling device 60, 62 is placed in a gelling oven 32 during curing of the stator 10. As many rolling devices 60 as possible are then preferably driven via an external actuator such as, for example, a motor; for example, the rolling devices 60 are driven via a common drive chain 86.

In some embodiments, the trickle unit 26 is configured in such a way that the actuator-free rolling device 60, 62 is installed in a stationary manner in the respective trickle or gelling regions, and the transport of the stator 10 or holder 48 with the stator 10 takes place without this rolling device 60, 62, for example by means of a robot grippers 126.

In some embodiments, the trickle unit 26 is configured in such a way that this actuator-free rolling device 60, 62 cycles from the trickle station to the gelling station, and directly transports the holder 48 or stator 10 with it in the process, preferably in a rotational manner without interruption. Here, the required energy for rotating the stator 10 is preferably introduced by different actuators into the rolling device 60, 62; this has the advantage that the actuator or the energy source for rotating the stator 10 does not also have to be cycled; it is therefore possible specifically in the case of cycling in a gelling oven 32 for expensive energy converters to be avoided such as, for example, motors within the hot region. The energy is introduced by means of a rotary drive mechanism 158, for example by means of a circulating drive chain 86, from the outside into the hot gelling region, and is forwarded by the rolling device 60 as far as the holder 48 or the stator 10 itself, with the result that it leads to the rotation of the holder 48 or stator 10.

In some embodiments, another energy source or motor for driving the rotation via the rolling device 62 is provided in a targeted manner specifically during trickling and the preferred swivelling, since swivelling movements in both directions are also provided for the rolling device 62 specifically during trickling; that is to say, the horizontal rotational axis of the stator 10 is pivoted into the vertical by preferably up to ±15° (or possibly even more) during trickling. As a result, it is difficult to drive all the rolling devices 60, 62 with one actuator or energy source such as, for example, a motor or a drive chain 86, and it is more appropriate, specifically during trickling, for the rolling device 62 to be driven individually or separately from the gelling or transport station via a drive which is mounted on the trickle station. This can take place, for example, via a separate chain which drives a plurality of shafts 90 via pinions.

In one embodiment of a rolling device 60, 62, at least two shafts 80, 90 are provided here, on which a total of at least three rollers 66 are situated which are positioned on preferably outer surfaces below the center in relation to the stator 10 or holder 48. Therefore, the stator 10 or holder 48 is held and positioned on at least three rollers 66 solely by way of gravity on these rollers 66.

Here, the axial positioning can take place by way of flanged discs 74 on the rollers 66, by way of V-shaped grooves 124 on the rollers 66, or by way of rollers of spherical configuration or by way of further rollers which are arranged axially or on the end side. In addition, at least one shaft 80, 90 of this rolling device 60, 62 is driven from the outside, and preferably all the shafts 80, 90 or rollers 66 are driven, whereby a rotation or turning of the stator 10 or holder 48 is introduced. The force or introduction of torque into the rolling device 60, 62 takes place here via friction wheels, chain sprockets, belt pulleys, or other possible transmission means. As has already been mentioned, the energy source or actuator is not situated here directly on the rolling device 60, 62. In addition, the rolling device 60, 62 does not have an actuator or energy source either, for clamping or holding the stator 10 on the rolling device 60, 62; the stators 10 or holders 48 remain in their position on the rolling device purely due to gravity.

During the trickle operation and during possibly provided swivelling of the stator 10 from the horizontal rotational position, it can be advantageous in the case of certain unfavorable stator designs that the cage or stator is additionally secured against tipping during the rotation; this is possible without relatively great problems in the case of the trickle station, however, since the trickle station is usually situated in a room temperature region and not within an oven 32, where this actuator system causes high costs. For example, in some embodiments, a temporary axial advance of, for example, supporting rollers onto the end sides of the holder 48 or stator 10 in the trickle region is possible without problems.

For an improved impregnation of stators (10) in mass production, holders (48) with at least one rolling surface (58a, 58b) and the unit components of a trickle unit (26) with a rolling device (60, 62) are proposed, on which the holders (48) with clamped-in stators (10) or else, in the case of stators (10) with a cylindrical outer surface suitable as a rolling surface (58a, 58b), the stators themselves lie. In this way, complicated actuators of clamping devices for holding the stators for trickling or gelling can be saved.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority

### LIST OF REFERENCE SIGNS

10 Stator
12 Internal clamping unit
14 Laminated core
16 Groove
18 Winding
20 Insulating paper
22a-22d Trickle nozzles
24 Trickle device
26 Trickle unit
28 Winding head
30 End surface
32 Oven
34 Trickle region
36a, 36b Gelling region
38 Curing region
40 Transport device
42 Conveyor belt
44 Handling unit
46 Robot arm
48 Holder
50 Gelling device
52 Curing device
54 Batch
55 Loading and unloading station
56 Clamping device
56a Axial clamping device
56b Radial clamping device
58a, 58b Rolling surface
60 Rolling device (gelling device)
62 Rolling device (trickle device)
64 Guide element
66 Roller
68 Rail
70 Transport chain, in particular circulating chain (example for traction mechanism of the conveyor belt)
72 Running surface
74 Flanged disc
76 Annular projection
80 Shaft
82, 82a, 82b Receiving roll
84, 84a, 84b, 84c Pinion
86, 86a, 86b, 86c Drive chain (rotation, example for rotary drive mechanism)
88 Lifting device
90 Lifting shaft
92 Trickle nozzle arrangement
94 Swivel device
96 Transfer region
98 Driver
100 Actuator on the driver
102 Actuator for resetting
104a, 104b, 104c Ring element
106 Strut
108 Spring
114 Common support
116 Bayonet, right
118 Bayonet, left
120 Clamping element
122 Worm/wedge mechanism
124 V-shaped groove
126 Gripper
128 Robot
130 Clamping mandrel
132 Rack
134 Frame
136 External drive
137 Torque introduction for rotation
138 Swivel axis
140 Swivel actuator
142 Transport track
144 Infeed region
146 Return region
148 First deflection region
150 Second deflection region
152 Deflection curve
154 First level
156 Second level
158 Rotary drive mechanism

1.-54. (canceled)

55. A trickle unit for the trickle impregnation of stators comprising:
a trickle device having a trickle region;
a gelling device having a gelling region; and
a transport device for transporting the stators from the trickle device to the gelling device with a plurality of holders for holding, turning, and transporting a stator in during an impregnation of the stator with resin, wherein each holder of the plurality of holders has a clamping device for clamping in the stator and at least one rolling surface for rolling support of a rotating holder with a clamped-in stator, wherein each holder of the plurality of holders comprises a cage which surrounds the clamped-in stator,
wherein the transport device includes a circulating system configured to cycle the stators clamped into the holders of the plurality of holders from the trickle region into the gelling region and the stators are rotated at least between the trickle region and the gelling region, or wherein the transport device includes a handling unit having a robot arm, or both.

56. The trickle unit according to claim 55, wherein each holder of the plurality of holders has at least one first rolling surface and at least one second rolling surface axially spaced from the at least one first rolling surface.

57. The trickle unit according to claim 55, wherein the at least one rolling surface is configured at least in regions in a cylinder shell-shaped manner, conical shell-shaped, spherical shell-shaped, or any combination thereof, or in a convexly curved manner or a concavely curved manner, in axial section, or has at least one groove, or any combination thereof, or
wherein the at least one rolling surface (has at least one first peripheral conical region and at least one second peripheral conical region, wherein the first conical region and the second conical region are inclined in a manner which is directed counter to one another, or are of mirror-inverted configuration with respect to one another, or both, or
wherein a peripheral toothing system is provided for driving a rotation of the holder in a positively locking manner with a clamped-in-stator, or
any combination thereof.

58. The trickle unit according to claim 55, wherein the clamping device is provided to clamp in the stator in a radial, an axial, or both in a positively locking manner, a non-positive manner, or both on an outer side of the stator.

59. The trickle unit according to claim 55, wherein the gelling device, the trickle device, the transport device, or any combination thereof have a rolling device configured to hold at least one holder with a clamped-in-stator by placing the at least one rolling surface on said rolling device and to rotate about a rotational axis which coincides with a central axis of the clamped-in-stator.

60. The trickle unit according to claim 59, wherein the rolling surface of the trickle device is configured to lift the at least one holder rolling on the trickle device with a stator clamped in it the at least one holder or to incline the at least one holder relative to the horizon, or both, or
wherein the trickle unit is provided with a plurality of trickle nozzles for trickling resin onto winding heads on both sides of the stator which is clamped in in the holder, or
both.

61. The trickle unit according to claim 59, wherein the rolling device has a plurality of guide elements, onto which the at least one rolling surface is placed, and
wherein the guide elements of the plurality of guide elements are configured to guide the holder in such a way that the holder performs a concentric rotation about a longitudinal axis.

62. The trickle unit according to claim 61, wherein the guide elements of the rolling device are selected from a group consisting of: rollers, pinions, contoured wheels, toothing systems, rails, circulating chains, running surfaces, rollers with flanged discs, rollers with V-shaped grooves, rollers with a spherical running surface, rollers with an annular projection on the running surface, rollers with grooves on the running surface, rollers which are connected by a chain or a conveyor belt, actively driven rollers, actively driven pinions, or rollers, pinions and contoured wheels connected by a common shaft, or
wherein at least one of the guide elements of the rolling device is configured to introduce a rotational movement into the holder, or
wherein one or more of the guide elements are configured to be rotated about in each case one rotational axis, a position of which differs from a position of a rotational axis of the holder, or
wherein the guide elements comprise a first to fourth roller, wherein the first roller and the second roller act, spaced apart axially from one another, on the at least one rolling surface of the holder in an angular position between 3 o'clock and 6 o'clock, and the third roller and the fourth roller act, spaced apart axially from one another, on the at least one rolling surface in an angular position between 6 o'clock and 9 o'clock, or
any combination thereof.

63. The trickle unit according to claim 59, wherein the rolling device has adjacent bearing positions for a first holder and a second holder,
wherein a common shaft or roller is arranged between the bearing positions, on which shaft or roller the first holder and the second holder lie, so that a rotation of one of the first holder and second holder is transmitted via the common shaft or roller to the other of the first holder and second holder, or so that the first holder and the second holder are driven rotationally via the common shaft or roller.

64. The trickle unit according to claim 59, wherein the trickle unit is provided with a conveyor belt with rolling devices which are configured for rotational support of the at least one rolling surface of the holder, and
wherein the conveyor belt is configured to convey the stators which are held in the holders through a plurality of unit components which are arranged behind one another in a conveying direction.

65. A method for the trickle impregnation of a plurality of stator each provided with a winding, the method comprising:
providing a holder for each stator, the holder having a clamping device for clamping in the respective stator and at least one rolling surface for rolling support of the rotating holder with a clamped-in-stator and which comprises a cage which surrounds the clamped-in-stator;
clamping the respective stator into the clamping device, wherein each stator is held for trickling and gelling in a dedicated holder;
performing a trickling and a gelling on the stators which are held on the holders, wherein the holders roll over the at least one rolling surface in order to rotate the stators; and,
transporting the stator from the trickling to the gelling so that a station is released for a next stator in such a way that trickling and gelling occur at the same time.

66. The method according to claim 65, wherein the holder with a clamped-in-stator is held solely by gravity in a trickle device for trickle impregnation by placing the at least one rolling surface on a rolling device of the trickle device, and is rotated about a rotational axis which coincides with a central axis of the stator,
wherein the holder which rolls on the rolling device of the trickle device is inclined during trickling by the rolling device about a substantially horizontal swivel axis which extends transversely with respect to the rotational axis, or the respective holder with a clamped-in-stator is lifted for trickling from a delivery track by the rolling device of the trickle device, or both.

67. The method according to claim 65, wherein the respective holder with a clamped-in-stator is held solely by gravity in a gelling device for gelling by placing the at least one rolling surface on a rolling device of the gelling device, and is rotated about a rotational axis which coincides with a central axis of the stator, or
wherein the holder with a clamped-in-stator is held solely by gravity in a trickle device for trickle impregnation by placing the at least one rolling surface on a rolling device of the trickle device, and is rotated about a rotational axis which coincides with a central axis of the stator, or
both.

68. The method according to claim 67, wherein the at least one rolling surface is placed on the guide elements of the respective rolling device,
wherein the guide elements guide the holder in such a way that the holder carries out a concentric rotation about a longitudinal axis.
